(19) United States
(12) Patent Application Publication
(10) Pub. No.: US 2025/0291848 A1
(43) Pub. Date: Sep. 18, 2025

(54) DYNAMICALLY CONSTRUCTING A GRAPH REPRESENTATION OF MULTIPLE IDENTITY SPACES

(71) Applicant: Zeta Global Corp., New York, NY (US)

(72) Inventors: Sekhar Sahu, San Francisco, CA (US); Kopal Sinha, San Francisco, CA (US); Prabhat Keni, San Francisco, CA (US)

(21) Appl. No.: 19/078,251

(22) Filed: Mar. 12, 2025

Related U.S. Application Data
(60) Provisional application No. 63/564,445, filed on Mar. 12, 2024.

(51) Int. Cl. G06F 16/901; G06Q 30/0251

(52) U.S. Cl. CPC G06F 16/9024; G06Q 30/0269

(57) ABSTRACT

The subject technology implements a unified query frame that may retrieve identity records from multiple, asymmetric identity spaces. The unified queries of the unified query framework may include one or more steps, one or more paths, and a resolution scheme that may extract sets of identity records from multiple identity spaces. The unified query framework may be implemented in a graph analysis system that generates one or more identity subgraphs using the extracted sets of identity records. One or more aspects of the unified queries and or identity subgraphs may be configured to customize the data retrieval process for one or more applications. One or more search operations of the graph analysis system may be optimized to improve the speed and efficiency of data retrieval and reduce compute resources and cost.

### PRIORITY CLAIM

This patent application claims the benefit of priority, under 35 U.S.C. Section 119 (e), to Sahu et al, U.S. Provisional Patent Application Ser. No. 63/564,445, entitled “DYNAMICALLY CONSTRUCTING A GRAPH REPRESENTATION OF MULTIPLE IDENTITY SPACES,” filed on Mar. 12, 2024 (Attorney Docket No. 4525.199PRV), which is hereby incorporated by reference in its entirety.

### TECHNICAL FIELD

The subject matter disclosed herein generally relates to the technical field of query processing across diverse datasets and, more specifically, to efficiently constructing subgraphs from multiple asymmetric graph representations.

### BACKGROUND

Graph analysis is an important type of data analytics where the underlying dataset is modeled as a graph. Since such a graph representation captures relationships between data entities, applying graph analysis procedures can provide valuable insight about the original dataset to the user. Examples of popular graph analysis procedures are identity resolution, community detection, page rank, shortest path finding, and link prediction.

Currently graph analysis is performed on static graphs stored in siloed datastores. As a result, traditional graph analysis methods cannot be applied to asymmetric graph representations, thereby limiting the size and the richness of the graph datasets that may be evaluated. The technology described herein improves existing graph analysis techniques by providing a novel query framework that may be used to construct targeted, query specific subgraphs from multiple, asymmetric graph representations each having different structures and characteristics. The novel query framework may search over different identity spaces using a network of configurable paths that may be determined at runtime. The query framework may rapidly adapt to new data sources and changes to existing identity spaces (e.g., adding or removing nodes) to make graph analysis systems more dynamic, faster, and more efficient. The query framework may also rapidly adapt to specific users, data requests, and/or applications to provide more targeted data retrieval and more customized subgraph construction.

### BRIEF DESCRIPTION OF THE DRAWINGS

Some embodiments are illustrated by way of example and not limitation in the figures of the accompanying drawings.

FIG. 1 is a block diagram illustrating a high-level network architecture, according to various embodiments described herein.

FIG. 2 is a block diagram showing architectural aspects of an identity resolution server, according to various embodiments described herein.

FIG. 3 is a block diagram illustrating a representative software architecture, which may be used in conjunction with various hardware architectures herein described.

FIG. 4 is a block diagram illustrating components of a machine, according to some example embodiments, able to read instructions from a machine-readable medium (e.g., a machine-readable storage medium) and perform any one or more of the methodologies discussed herein.

FIG. 5 depicts aspects of an implementation of one or more components of an application server, according to various embodiments described herein.

FIG. 6 depicts additional aspects of a graph analysis system, according to various embodiments described herein.

FIG. 7 illustrates more details of one or more resolution rules of a resolution scheme, according to various embodiments described herein.

FIG. 8 is a flow chart illustrating more details of an identity resolution operation performed by the graph analysis system, according to various embodiments described herein.

FIG. 9 illustrates a process for using an identity subgraph to configure a media campaign, according to various embodiments described herein.

FIG. 10 is a flow chart depicting operations in a method, according to various embodiments described herein.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

The graph analysis system may be used to retrieve identity data from multiple asymmetric data sources. Identity data retrieved by the graph analysis system may include sensitive data such as, for example, personal identifiable information (e.g., first name, last name, postal address, email address, and the like) and device information (e.g., mobile device ids (MAIDs), connected television device ids (CTVIDs), IP addresses, cookies, and the like) that may have specific storage and/or processing requirements. For example, one or more pieces of the personal identifiable information and/or device information may include additional security requirements and/or use restrictions specified by one or more privacy regulations. Identity data becomes outdated frequently and quickly as people move, get new devices, change email accounts they maintain, and the like. Current approaches to storing identity data are fragmented and siloed as a result of the sensitive and transient nature of the data. Typically, the identity data for an individual is spread out among many different data sources, with each source including only a fragment of the identity data for that individual. Identity data for populations of individuals is similarly fragmented with each data source only storing a portion of the identity data for a fraction of the individuals in a population.

The graph analysis system implements a unified query framework that may be used to connect mosaics of different data sources to support quick and efficient retrieval of a comprehensive set of identity data for target individuals and populations. The unified query framework generates unified queries that link multiple asymmetric identity spaces to make disparate data sources interoperable. The query results from each identity space may be combined to generate identity graphs that include comprehensive identity data for a list of ids in a target segment. The graph analysis system provides a configurable interface that automatically builds unified queries for each data retrieval job at runtime. The graph analysis system may reference real time mapping data for all available identity spaces during query generation to dynamically determine a set of paths that may be used to navigate across different identity spaces. The paths may include step sequences that list identifier types for identifiers that are linked across different identity spaces. The steps sequences included in each path may reveal identifier types for one or more linking identifiers that may appear in multiple identity spaces. The linking identifiers link multiple identity spaces because they may be used to lookup identity records in each of the identity spaces where they appear. The combination of a source id and a linking id may be used to search for identity records for the same individual in multiple identity spaces (e.g., the identity spaces that include an identifier type (e.g., cookie id) that matches the identifier type of the source id and identity spaces that include an identifier type (e.g., email id) that matches the identifier type of the linking id. The unified query framework is flexible and may be adapted to support unique sets of parameters (e.g., storage formats, configurations, schemas, and the like) for different data sources to enable identity data to be retrieved from multiple, different data sources that may each have different configurations and store different sets identity records. The flexibility of the query framework and dynamic query generation enables the graph analysis system to adjust the unified query framework rapidly to expand the reach of the unified queries to new data sources and identity spaces and support updates to existing data sources and identity spaces.

To build the unified queries, the graph analysis system may map the identity spaces of each data source to understand the identity data stored in each space and identify the linking ids that may appear in multiple, different spaces. The mapping information may be updated in real time to adapt to new and/or updated data sources and/or identity spaces. At runtime, the graph analysis system may access the mapping information via one or more application programing interfaces (APIs) or other endpoints and/or services and use it to generate a custom unified query for each data request. The unified query may be configured based on the type of ids for the source ids included in the data request, the desired target identity data, and one or more user preferences specified by the user. The graph queries may include a combination of steps and paths that identify the identity spaces and/or data sources required to retrieve the data requested in each data request. The paths may connect the required identity spaces and/or data sources using one or more id linkages (e.g., linking ids) that may be determined based on the steps. The graph analysis system may navigate between different identity spaces and/or data sources using the paths to retrieve the portion of the requested data included in each identity space and/or data source. For example, the graph analysis system may use the linking ids to join identity records from other identity spaces to the records retrieved from an initial identity space using a set of source ids.

The unified queries may also include a set of resolution rules that optimize the data retrieval process for one or more parameters. For example, the resolution rules may specify a hierarchy for the different identity spaces so that identity spaces with higher confidence are searched first. The resolution rules may also rank order different pieces of identity data within the identity records of the same identity space so that source ids may be matched to higher resolution identifiers first (e.g., identifiers that are more specific, durable, reliable, and the like) before attempting more relaxed matches for unresolved source ids. One or more of the steps, paths, and resolution rules may be configured by users to tailor the identity data output for one or more applications. For example, the unified queries may be configured to return identity data resolved at a particular confidence level and/or resolution rate. The unified queries may also be configured to enable one or more identity spaces and/or data sources to be used selectively. For example, the unified queries may be configured to limit the use of permissioned datasets (e.g., proprietary identity spaces, identity spaces and/or data sources that include personal information, and the like) to instances where use is authorized.

The identity data retrieved by the unified queries may be filtered to further refine the results for one or more applications. The filtered identity data from each identity space and/or data source may then be combined into an identity subgraph that stiches all of the data together using the linkages included in the steps and/or paths. The subgraphs may have a graph structure to enable the relationships between the identity data retrieved from each identity space and/or data source (e.g., the connections along the linkages) to be included in the subgraphs. Relationships between identity data retrieved from the same identity space and/or data source may also be shown in graph structure of the subgraphs. The subgraphs may also include unified ids for each set of identity records that corresponds to the same individual or entity. Each of the unique ids included in the filtered identity data for an individual may be linked to the unified id so that the unified id may be used to retrieve all of the identity records for an individual that are included in the subgraphs.

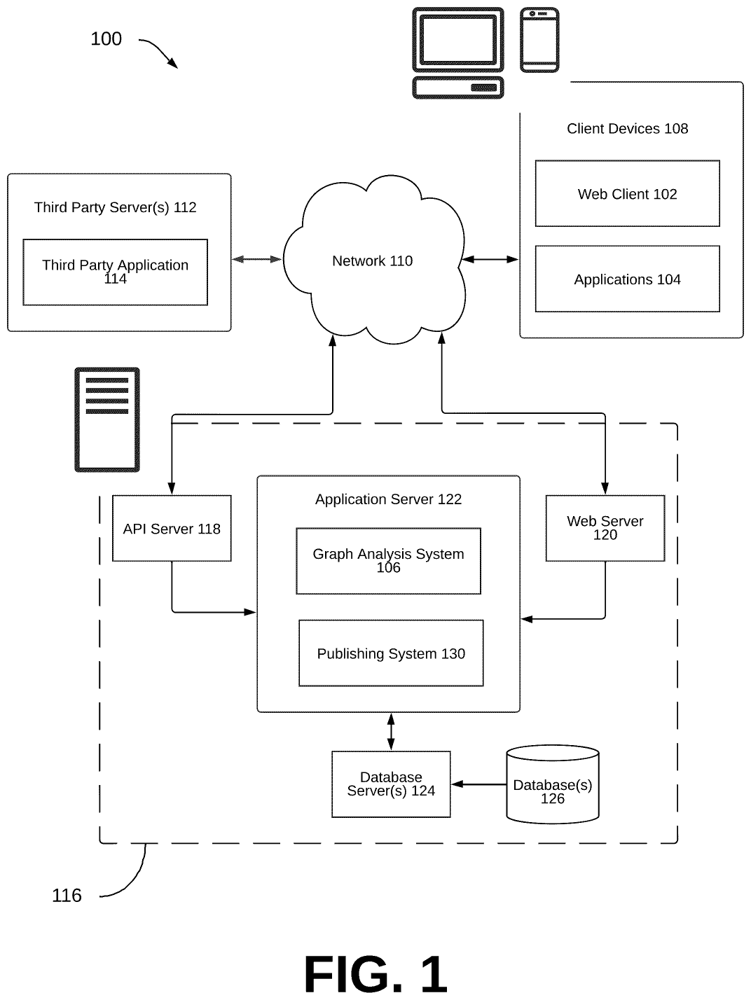

The graph analysis system may be implemented within the SaaS network architecture described in FIG. 1 below so that the data retrieval functionality may be scaled to run multiple queries simultaneously across multiple identity spaces and/or data sources. The network architecture also integrates the graph analysis system within a media publication platform to enable the identity data retrieved by the system to be used to facilitate targeted delivery of content. For example, the media publication platform may use the retrieved identity data to configure targeted content campaigns that are specific to a brand, product, or subject matter of interest.

With reference to FIG. 1, an example embodiment of a high-level SaaS network architecture 100 is shown. A networked system 116 provides server-side functionality via a network 110 (e.g., the Internet or WAN) to one or more client devices 108. A web client 102 and a programmatic client, in the example form of a client application 104, are hosted and execute on the client devices 108. The networked system 116 includes an application server 122, which in turn hosts a graph analysis system 106 and a publishing system 130) that provides a number of functions and services to the client application 104 that accesses the networked system 116. For example, the graph analysis system 106 may retrieve identity data from multiple asymmetric data sources and/or identity spaces and the publishing system (e.g., a demand side platform (DSP), message transfer agent (MTA), and the like) may use the identity data to configure one or more targeted content campaigns.

The client application 104 may provide a number of graphical user interfaces (GUIs) that may be displayed on one or more client devices 108 and may receive inputs thereto to configure an instance of the client application 104 and operate one or more applications hosted by the application server 122. For example, the client application 104 may provide query configuration interfaces that may be used to configure data requests processed by the graph analysis system 106. The client application 104 may also provide one or more user interfaces for the publishing system 130. For example, the client application 104 may provide, for example, campaign setup user interfaces for selecting campaign configuration settings, a content personalization user interface for editing and/or viewing campaign content, campaign monitoring user interfaces for tracking campaign performance, and the like. The user interfaces provided by the client application 104 can present outputs to a user of the client device 108 and receive inputs thereto in accordance with the methods described herein.

The client devices 108 enable users to access and interact with the networked system 116 and, ultimately, the graph analysis system 106. For instance, users provide inputs (e.g., touch screen input or alphanumeric input) to the client devices 108, and the inputs are communicated to the networked system 116 via the network 110. In this instance, the networked system 116, in response to receiving the inputs from users, communicates information back to the client devices 108 via the network 110 to be presented to the users.

An API server 118 and a web server 120 are coupled, and provide programmatic and web interfaces respectively, to the application server 122. The application server 122 hosts the graph analysis system 106, which includes components described further below. The application server 122 may also host a publishing system 130 that uses identity data provided by the graph analysis system 106 to configure one or more targeted media campaigns. The application server 122 is shown to be coupled to a database server 124 that facilitates access to information storage repositories (e.g., a database 126). The database 126 may include storage devices that store information accessed and/or generated by the graph analysis system 106.

The publishing system 130 may be a demand side platform (DSP), email service provider (ESP) or other system that distributes content digitally over the network 110. For example, the publishing system 130 may be a DSP that includes an integrated bidding exchange, an online demand side portal accessible to a targeted content provider, and an online supply side portal accessible to a publisher of content on the network 110. The bidding exchange may be communicatively coupled to the demand side portal and the supply side portal to present user interfaces enabling receipt of bids from a brand or other media provider for placement of media by a publisher at a specified location or domain in available inventory on the network 110. The demand side portal may be configured to reserve, upon resolving of a successful bid from the media provider, the specified location or domain for placement of media. The demand side portal may then publish the piece of media at the reserved placements. Users accessing the locations including the reserved placements may view and engage with the media. In some examples, the publication system 130 is further configured to process a transaction between the media provider and the publisher based on the presentation or a viewing of the targeted media by the consumer, or a third party.

The publication system 130 may use the identity data provided by the graph analysis system 106 to determine which locations to publish media. For example, the publication system 130 may be configured to publish media at the specified location or domain on the network that will be accessed by one or more target consumers or client devices that are identified from the identity data. Accordingly, the publication system 130 and graph analysis system 106 may work in concert to enable scalable, targeted online media campaigns that publish personalized content to users in a target audience.

In embodiments having a publication system 130 including an ESP, the ESP and the graph analysis system 106 may work in concert to enable scalable, targeted email campaigns that publish personalized email content to users in the target audience. The graph analysis system 106 may provide email addresses and other contact information for users in the targeted audience so that emails including personalized content may be distributed to that target audience by the ESP.

The network architecture 100 may also include a third-party application 114, executing on one or more third-party servers 112, that is shown as having programmatic access to the networked system 116 via the programmatic interface provided by the API server 118. For example, the third-party application 114, using information retrieved from the networked system 116, may support one or more features or functions on a data storage system, generative AI system, website, streaming platform, and the like hosted by a third party.

Turning now specifically to the applications hosted by the client device 108, the web client 102 may access the various systems (e.g., the graph analysis system 106) via the web interface supported by the web server 120. Similarly, the client application 104 (e.g., a data retrieval “app”, digital marketing “app” and the like) accesses the various services and functions provided by the graph analysis system 106 via the programmatic interface provided by the API server 118. The client application 104 may be, for example, a web application, an “app” executing on the client device 108, such as an iOS or Android OS application or other software application executing on the client device 108. The client application 104 may enable a user to access and input data on the networked system 116 in an offline manner and to perform batch-mode communications between the client application 104 and the networked system 116.

Further, while the SaaS network architecture 100 shown in FIG. 1 illustrates one example of a client-server architecture, the present inventive subject matter is of course not limited to such an architecture, and could equally well find application in a distributed, or peer-to-peer, architecture system, for example. The present invention may also be implemented using other configurations of a client-server architecture. In various embodiments, the SaaS architecture 100 may include multiple application servers 122 that are each optimized for a particular application. For example, the application servers 122 may include an identity resolution server that hosts the graph analysis system 106 and other components used to retrieve identity data. The application servers 122 may also include a publishing server that hosts the publishing system 130 and other components that are used to configure and run media campaigns over the network 110. The graph analysis system 106 could also be implemented as a standalone software program, which does not necessarily have networking capabilities.

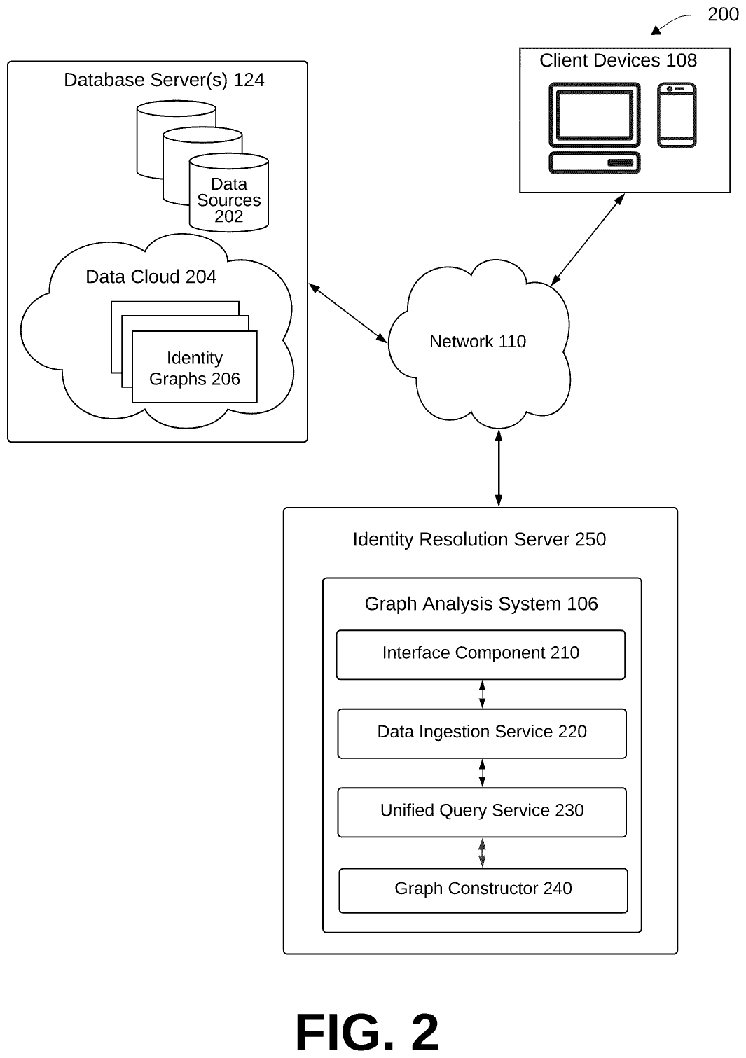

FIG. 2 is a block diagram showing details a networked data storage and management system 200 for retrieving identity data from multiple asymmetric identity spaces. The networked data storage and management system 200 may be implemented using a client server architecture that includes multiple specialized servers and one or more client devices 108 connected via a network 110 (e.g., the Internet). The specialized servers may each be optimized for a particular application and may include, for example, a database server 124 (e.g., the database server of FIG. 1) and an identity resolution server 250. The database server 124 may host multiple data sources 202 that may each include one or more identity spaces. The data sources 202 may include databases and file systems that store identity data. The data sources 202 may include different database types (e.g., relational databases, graph database, unstructured storage databases, and the like) that may store identity data in different ways. The data sources 202 may include identity data from one or more third party and/or first party datasets and different datasets may be stored in different storage formats based on the type of relationships between the data that are contained in each of the datasets. Each of the data sources 202 may include one or more identity spaces that store different sets of identity records. The data sources 202 may leverage one or more distributed storage frameworks to help consolidate large datasets. The data sources 202 may also include one or more data warehouse platforms integrated with the one or more distributed storage frameworks which may provide data query and analysis functionality.

The identity resolution server 250 may include a graph analysis system 106 that may interface with the database server 124 to extract identity data from one or more data sources 202. The graph analysis system 106 may also use the extracted identity data to construct identity graphs 208 that are stored in a and a data storage and management platform (e.g., a data cloud 204) hosted by the database servers 124. One or more servers (e.g., the application server of FIG. 1) may access the data cloud 204 to use the identity graphs 206 for one or more applications (e.g., identity resolution, look alike modeling, media campaign configuration, and the like). The graph analysis system 106 may provide a unified query framework that may be used to extract identity data from any of the data sources 202 using a single configurable query interface.

The graph analysis system 106 may include an interface component 210 that may enable other components of the SaaS network architecture of FIG. 1 and/or the networked data storage and management system 200 to communicate with the graph analysis system 106. For example, interface component 210 may receive data requests from a client application running on one or more client devices 108 and/or a publishing system hosted by an application server. The interface component 210 may communicate identity data retrieved for each data request to the requesting client device 108 and/or application server. In various embodiments, the interface component 210 may connect to one or more campaign configuration components of a publishing system that operate to provide specific aspects of configuring and optimizing media campaigns that distribute content. The interface component 210 may configure and optimize the data requests based on the configuration settings for the campaign received from the campaign configuration components. For example, the campaign configuration component may be used to identify an audience of target consumers that may receive personalized content in a campaign. The interface component 210 may generate a data request for the campaign based on the configuration settings from the campaign configuration component. The data request may include, for example, a list of source ids for a target audience and a required output id type.

The graph analysis system may include a data ingestion service 220 that generates mapping data for the data sources. The mapping information may include a list of the identity spaces included in each data source as well as the identifier types included in each identity space. A unified query service 230 may use the mapping data to generate unified queries that resolve one or more identifiers for a population of users included in a target audience of a media campaign. For example, the unified queries may resolve one or more identifiers for a list of source ids included in a data request received by the interface component 210. The unified query service 230 may resolve the one or more identifiers for the users in the target audience by matching the source ids in the data request with one or more lookup identifiers included in identity records stored in one or more identity spaces. The source id may include a unique identifier for a user, for example, a first name, last name, physical address, cookie, device_ID, email address, user_ID, and the like. One or more of the unique identifiers may be encrypted using a hash algorithm (e.g., SHA-256) or other encryption algorithm. The hashed and/or encrypted version of the unique identifier may be included as source ids in data requests and/or stored as identifiers in one or more identity records included in one or more of the identity spaces.

A graph constructor 240 may combine the identity data retrieved by the unified query service 230 into identity graphs 206 that are stored in a data cloud 204. The identity graphs 206 may include multiple nodes and edges connecting two or more nodes. Each node may include a unique identifier and/or identity attribute associated with the identifier. The edges between the nodes may represent a relationship between one or more identifiers and/or identity attributes. For example, an edge connecting two identifier nodes may represent an identifier linkage between the two identifiers that links both identifiers to the same user, device, or other entity (e.g., both identifiers are included in identity records that include a shared “linking” identifier). An edge connecting an identifier node and an identity attribute node may represent that the connected identifier and identity attributes were included in the same identity record, extracted from the same identity space, relate to the same user and/or device, and the like. One or more identity attributes associated with a unique identifier may also be stored as node metadata included in the identifier node.

The identity attributes may include one or more consumer attributes of a user. The consumer attributes may include one or more pieces of user data (e.g., location data, demographic data, device metadata, machine learned attributes, interest codes, and the like), event data (e.g., opens, clicks, impressions, conversions and other engagement data) and transaction data (purchase records, purchase amounts, transaction metadata, and the like) associated with a user. For example, one identifier node may include an email address type identifier (e.g., targetcustomer@gmail.com) and the identity attributes included in identity attribute nodes connected to the identifier node and/or included as node metadata may include event data recorded for the email address. For example, the event data may include multiple events each having a timestamped record of an event type (e.g., sent event, delivery event, open event, click event, view event, conversion event, and the like) performed by the email account having the email address. Other identity attributes that may stored as node metadata and/or included in identity attribute nodes connected to the identifier node may include event data record for the email address. The transaction data may include timestamped records of a transaction type (e.g., purchase, return, refund, and the like) performed by a user account associated with the email address.

One or more machine learned scores may also be included as identity attributes that are included in identity attributes and/or stored in node metadata. The machine learned scores may be determined using one or more machine learning models trained on data cloud data (e.g., customer data, event data, transaction data stored in identity graphs 208) and/or one or more external datasets. The machine learned scores may include I-scores indicating a consumer's interest in a brand or likelihood to purchase a product and P-scores indicating a behavioral traits and other aspects of a consumer's personality. The I-scores may include brand propensity scores (e.g., a predicted likelihood a consumer will shop at store of a particular brand, purchase a particular brand of athletic shoes or other goods, view content published by a particular on one or more digital media channels, and the like), brand affinity scores (e.g., a predicted likelihood of how frequently and/or consistently consumers engage with particular brands, for example, how often consumers will purchase products made by the brand, click or view ads or emails sent by the brand, visit a particular brand website, and the like), product propensity scores (e.g., a predicted likelihood a consumer will by or show interest in (e.g., view/click content related to) particular products or services), and the like. P-scores may include an attitude or behavioral propensity score (e.g., a predicted likelihood a consumer is materialistic, athletic, health conscious, frugal, aggressive, or other personality trait) or a channel propensity score (e.g., a predicted likelihood a consumer will engage with content on email, web page display, mobile display, connected tv, linear tv, gaming, social media, or other digital media channel).

To resolve one or more identifiers of a target identifier type for a target user, the unified query service 230 may generate a unified query that parses one or more identity spaces according to one or more steps, paths, and/or resolution rules included in the unified query. The unified query may identify one or more matches between a source id included in the data request and a lookup id for an identity record in an identity space. During identity resolution, the unified query service 230 may match a source id to a single lookup id (e.g., a single node) or a cluster of multiple related lookup ids (e.g., a cluster of multiple connected nodes). The unified query service 230 may match the source id with an lookup id or cluster of multiple lookup ids using a tiered matching scheme that includes one or more identity resolution rules that prioritize an identifier of one identifier type over one or more other identifiers of different identifier types based on a value of a confidence metric or other parameter. The confidence metric may be determined based on how recently and/or frequently an identifier and/or identifier type was used. For example, the confidence metric may be determined based on a frequency parameter and a recency parameter. The frequency parameter may measure how many pieces of event data and/or transaction data associated with the identifier were recorded by the database servers 124 within a predetermined period of time (e.g., 30 days, 90 days, or any other time period). The recency parameter may measure a period of time passed since the identifier was last confirmed to be in use (e.g., an elapsed time since a piece of event data associated with the identifier was recorded by the database servers 124. Identifiers and/or identifier types that are used more recently and have larger values for the recency parameters and/or are used more frequently and have higher values for the frequency parameter may have a larger value for the confidence metric and may have a higher matching priority relative to identifiers that are used less frequently and/or recently and have lower confidence metrics.

The identity graphs 208 generated by the graph constructor 240 may include hundreds of millions of unique nodes and billions of edges. The identity graphs 208 may be dynamically updated by adding, deleting, and/or modifying nodes, node metadata, and/or edges based on new data from one or more new and/or updated identity spaces. The new data may include user, data, event data, and/or transaction data received from a demand side platform, email service provider, or other publishing system that distributes media (e.g., text, image data, video content, audio content, streaming content, extended reality (XR) content including virtual reality (VR) content, augmented reality (AR) content, mixed reality (MR) content and any other form of XR content, and the like) over the Internet or other computer network. A data ingestion service 220 may perform a data ingestion process each time a data source 202 is added and/or updated. The data ingestion process may map the identity data included in each of the identity spaces stored in the new and/or updated data sources and the links between the identity data in different identity spaces. The mapping information determined by the data ingestion 220 may be used to generate unified queries as described in more detail below.

To improve the efficiency and accuracy of the identity resolution process the unified query service 230 may generate the unified queries used to resolve one or more identifiers for a target audience in real time upon receiving a data request. The unified query service 230 may also perform identity resolution for a list of source ids on a pre-determined schedule (e.g., every hour, every day, and the like) and/or in response to the occurrence of a specific event (e.g., each time a new data source 202 is added, each time a data source 202 is updated, and the like). Regularity retrieving identity data for a target audience and constructing a new identity graph for each batch of retrieved identity data ensures the identity graphs for the target audience include accurate, updated information.

It should be understood that the networked data storage and management system 200 shown in FIG. 2 illustrates one example of a networked system architecture, the present inventive subject matter is of course not limited to such an architecture, and could equally well find application in a distributed, or peer-to-peer, architecture system, for example. It should be also be understood that the present inventive subject matter includes other configurations of the networked data storage and management system 200 that include amounts, types, and/or arrangements of components. For example, the graph analysis system 106 may include one or more instances of each of the components. For example, the graph analysis system 106 may include multiple instances of the interface component 210, data ingestion service 220 and unified query service 230, and/or graph constructor 240 with each instance being operated to interface with different application servers, client devices 108, data sources 202, and/or data clouds 206 respectively.

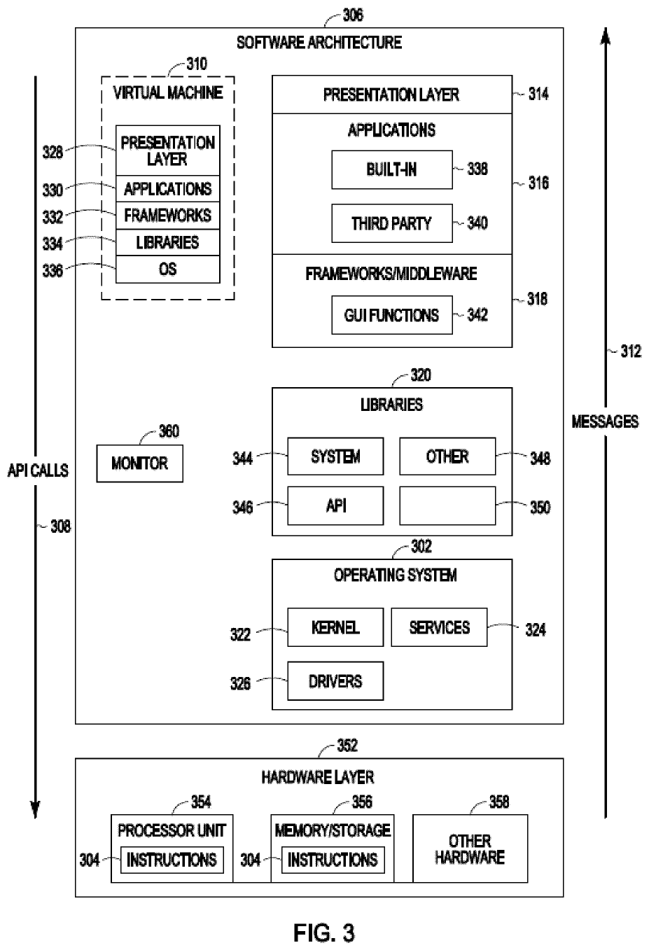

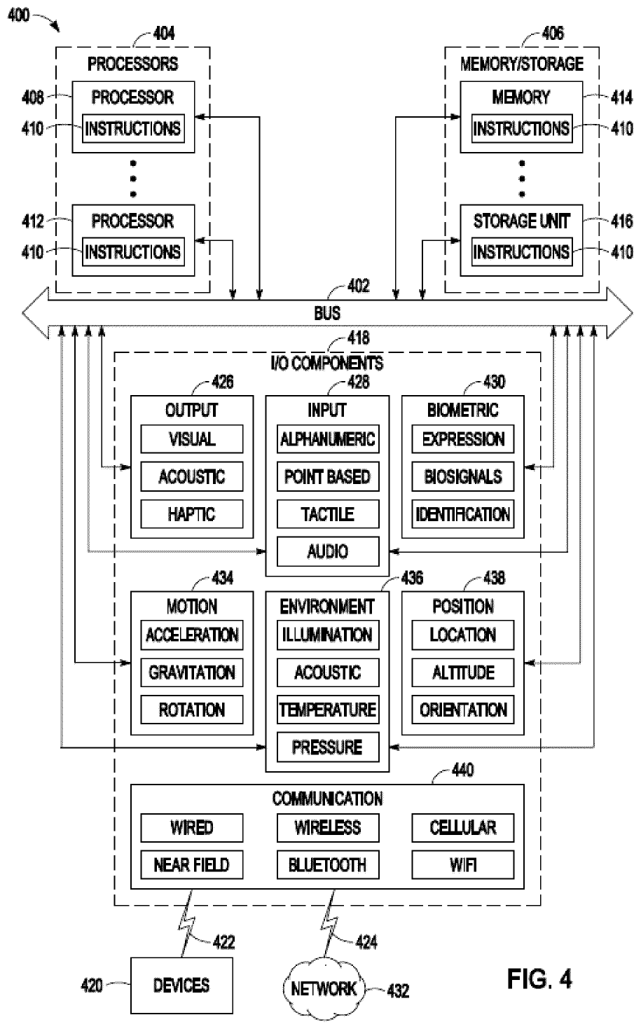

FIG. 3 is a block diagram illustrating an example software architecture 306, which may be used in conjunction with various hardware architectures herein described. FIG. 3 is a non-limiting example of a software architecture 306, and it will be appreciated that many other architectures may be implemented to facilitate the functionality described herein. The software architecture 306 may execute on hardware such as a machine 400 of FIG. 4 that includes, among other things, processors 404, memory/storage 406, and input/output (I/O) components 418. A representative hardware layer 352 is illustrated and can represent, for example, the machine 400 of FIG. 4. The representative hardware layer 352 includes a processor 354 having associated executable instructions 304. The executable instructions 304 represent the executable instructions of the software architecture 306, including implementation of the methods, components, and so forth described herein. The hardware layer 352 also includes memory and/or storage modules as memory/storage 356, which also have the executable instructions 304. The hardware layer 352 may also comprise other hardware 358.

In the example architecture of FIG. 3, the software architecture 306 may be conceptualized as a stack of layers where each layer provides particular functionality. For example, the software architecture 306 may include layers such as an operating system 302, libraries 320, frameworks/middleware 318, applications 316, and a presentation layer 314. Operationally, the applications 316 and/or other components within the layers may invoke API calls 308 through the software stack and receive a response as messages 312 in response to the API calls 308. The layers illustrated are representative in nature, and not all software architectures have all layers. For example, some mobile or special-purpose operating systems may not provide a frameworks/middleware 318, while others may provide such a layer. Other software architectures may include additional or different layers.

The operating system 302 may manage hardware resources and provide common services. The operating system 302 may include, for example, a kernel 322, services 324, and drivers 326. The kernel 322 may act as an abstraction layer between the hardware and the other software layers. For example, the kernel 322 may be responsible for memory management, processor management (e.g., scheduling), component management, networking, security settings, and so on. The services 324 may provide other common services for the other software layers. The drivers 326 are responsible for controlling or interfacing with the underlying hardware. For instance, the drivers 326 include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 320 provide a common infrastructure that is used by the applications 316 and/or other components and/or layers. The libraries 320 provide functionality that allows other software components to perform tasks in an easier fashion than by interfacing directly with the underlying operating system 302 functionality (e.g., kernel 322, services 324, and/or drivers 326). The libraries 320 may include system libraries 344 (e.g., C standard library) that may provide functions such as memory allocation functions, string manipulation functions, mathematical functions, and the like. In addition, the libraries 320 may include API libraries 346 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 320 may also include a wide variety of other libraries 348 to provide many other APIs to the applications 316 and other software components/modules.

The frameworks/middleware 318 provide a higher-level common infrastructure that may be used by the applications 316 and/or other software components/modules. For example, the frameworks/middleware 318 may provide various graphic user interface (GUI) functions 342, high-level resource management, high-level location services, and so forth. The frameworks/middleware 318 may provide a broad spectrum of other APIs that may be utilized by the applications 316 and/or other software components/modules, some of which may be specific to a particular operating system or platform.

The applications 316 include built-in applications 338 and/or third-party applications 340. Examples of representative built-in applications 338 may include, but are not limited to, a contacts application, a browser application, a book reader application, a location application, a media application, a messaging application, a publishing application, a content application, a campaign configuration application, performance monitoring application, a scoring application, and/or a game application. The third-party applications 340 may include any application developed using the ANDROID™ or IOS™ software development kit (SDK) by an entity other than the vendor of the particular platform and may be mobile software running on a mobile operating system such as IOS™, ANDROID™, WINDOWS® Phone, or other mobile operating systems. The third-party applications 340 may invoke the API calls 308 provided by the mobile operating system (such as the operating system 302) to facilitate functionality described herein.

The applications 316 may use built-in operating system functions (e.g., kernel 322, services 324, and/or drivers 326), libraries 320, and frameworks/middleware 318 to create user interfaces to interact with users of the system. Alternatively, or additionally, in some systems, interactions with a user may occur through a presentation layer, such as the presentation layer 314. In these systems, the application/component “logic” can be separated from the aspects of the application/component that interact with a user.

Some software architectures use virtual machines. In the example of FIG. 3, this is illustrated by a virtual machine 310. The virtual machine 310 creates a software environment where applications/components can execute as if they were executing on a hardware machine (such as the machine 400 of FIG. 4, for example). The virtual machine 310 is hosted by a host operating system (e.g., the operating system 302 in FIG. 3) and typically, although not always, has a virtual machine monitor 360, which manages the operation of the virtual machine 310 as well as the interface with the host operating system (e.g., the operating system 302). A software architecture executes within the virtual machine 310 such as an operating system (OS) 336, libraries 334, frameworks 332, applications 330, and/or a presentation layer 328. These layers of software architecture executing within the virtual machine 310 can be the same as corresponding layers previously described or may be different.

FIG. 4 is a block diagram illustrating components of a machine 400, according to some example embodiments, able to read instructions from a non-transitory machine-readable medium (e.g., a non-transitory machine-readable storage medium) and perform any one or more of the methodologies discussed herein. Specifically, FIG. 4 shows a diagrammatic representation of the machine 400 in the example form of a computer system, within which instructions 410 (e.g., software, a program, an application, an applet, an app, or other executable code) for causing the machine 400 to perform any one or more of the methodologies discussed herein may be executed. As such, the instructions 410 may be used to implement modules or components described herein. The instructions 410 transform the general, non-programmed machine 400 into a particular machine 400 programmed to carry out the described and illustrated functions in the manner described. In alternative embodiments, the machine 400 operates as a standalone device or may be coupled (e.g., networked) to other machines. In a networked deployment, the machine 400 may operate in the capacity of a server machine or a client machine in a server-client network environment, or as a peer machine in a peer-to-peer (or distributed) network environment. The machine 400 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 410, sequentially or otherwise, that specify actions to be taken by the machine 400. Further, while only a single machine 400 is illustrated, the term “machine” shall also be taken to include a collection of machines that individually or jointly execute the instructions 410 to perform any one or more of the methodologies discussed herein.

The machine 400 may include processors 404 (including processors 408 and 412), memory/storage 406, and I/O components 418, which may be configured to communicate with each other such as via a bus 402. The memory/storage 406 may include a memory 414, such as a main memory, or other memory storage, and a storage unit 416, both accessible to the processors 404 such as via the bus 402. The storage unit 416 and memory 414 store the instructions 410 embodying any one or more of the methodologies or functions described herein. The instructions 410 may also reside, completely or partially, within the memory 414, within the storage unit 416, within at least one of the processors 404 (e.g., within the processor's cache memory), or any suitable combination thereof, during execution thereof by the machine 400. Accordingly, the memory 414, the storage unit 416, and the memory of the processors 404 are examples of machine-readable media.

The I/O components 418 may include a wide variety of components to receive input, provide output, produce output, transmit information, exchange information, capture measurements, and so on. The specific I/O components 418 that are included in a particular machine will depend on the type of machine. For example, portable machines such as mobile phones will likely include a touch input device or other such input mechanisms, while a headless server machine will likely not include such a touch input device. It will be appreciated that the I/O components 418 may include many other components that are not shown in FIG. 4. The I/O components 418 are grouped according to functionality merely for simplifying the following discussion, and the grouping is in no way limiting. In various example embodiments, the I/O components 418 may include output components 426 and input components 428. The output components 426 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 428 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further example embodiments, the I/O components 418 may include biometric components 430, motion components 434, environment components 436, or position components 438, among a wide array of other components. For example, the biometric components 430 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 434 may include acceleration sensor components (e.g., accelerometer), gravitation sensor components, rotation sensor components (e.g., gyroscope), and so forth. The environment components 436 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas sensors to detect concentrations of hazardous gases for safety or to measure pollutants in the atmosphere), or other components that may provide indications, measurements, or signals corresponding to a surrounding physical environment. The position components 438 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 418 may include communication components 440 operable to couple the machine 400 to a network 432 or devices 420 via a coupling 424 and a coupling 422, respectively. For example, the communication components 440 may include a network interface component or other suitable device to interface with the network 432. In further examples, the communication components 440 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 420 may be another machine or any of a wide variety of peripheral devices (e.g., a peripheral device coupled via a USB).

Moreover, the communication components 440 may detect identifiers or include components operable to detect identifiers. For example, the communication components 440 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 440, such as location via Internet Protocol (IP) geo-location, location via Wi-Fi® signal triangulation, location via detecting an NFC beacon signal that may indicate a particular location, and so forth.

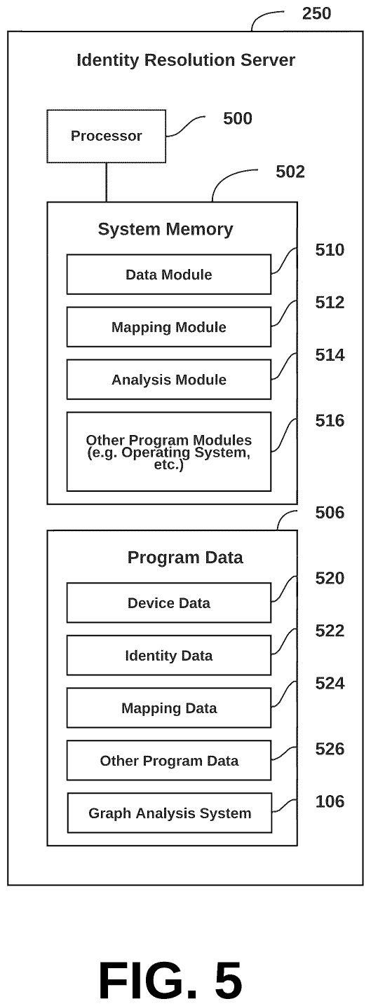

With reference to FIG. 5, an identity resolution server 250 hosting a graph analysis system may include at least one processor 500 coupled to a system memory 502. The system memory 502 may include computer program modules and program data 506. In this implementation, program modules may include a data module 510, a model module 512, an analysis module 514, and other program modules 516 such as an operating system, device drivers, and so forth. Each module 510 through 516 may include a respective set of computer-program instructions executable by one or more processors 502.

This is one example of a set of program modules, and other numbers and arrangements of program modules are contemplated as a function of the particular design and/or architecture of the content engine. Additionally, although shown as a single server, the operations associated with respective computer-program instructions in the program modules could be distributed across multiple computing devices. Program data 508 may include device data 520, identity data 522, and mapping data 524, and other program data 526 such as data input(s), third-party data, and/or others. In some examples, the program data 508 includes a graph analysis system 106.

Some examples provide graph analysis systems that generate identity subgraphs for a selection of source ids. The identity subgraphs may include identity data extracted from multiple, asymmetric identity spaces. The graph analysis system may provide a flexible, unified query framework for extracting identity data from multiple, asymmetric identity spaces that may each include different data structures (e.g., graph, table, hierarchical, districuted, relational, non-relational, and the like), different identifiers, different identifier types, and different amounts of identity data (e.g., different numbers of unique identifiers, different numbers of unique identifier values for each intensity type, and the like). The multiple, asymmetric identity spaces that are queryable using the unified query service may have different data structures, storage formats, may be persisted in different data sources, and/or may be managed by different data management platforms. The unified queries produced by the graph analysis system may be configurable to customize data retrieval tasks for one or more applications. For example, the unified queries may be configured to run identity resolution jobs that are optimized for reach and/or confidence. The unified queries may also be configurable to exclude and/or include one or more data sources. The flexible unified query framework may also be rapidly adapted to support new and/or updated identity spaces and/or data sources. The flexibility of the unified query framework makes new data easy to onboard into the framework and makes it easier to implement changes to data access, persistence, and security.

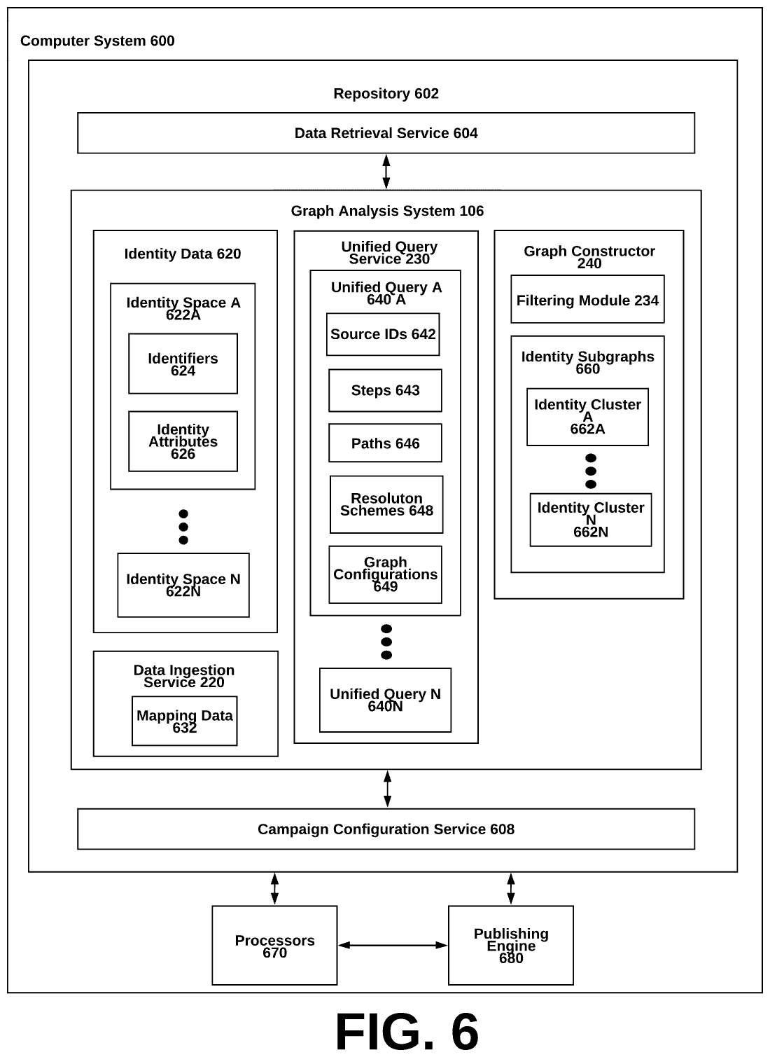

FIG. 6 is a block diagram illustrating more details of the graph analysis system 106 in accordance with one or more embodiments of the disclosure. The graph analysis system 106 may be implemented using a computer system 600. In various embodiments, the computer system 600 may include a repository 602, a publishing engine 680, and one or more computer processors 670. In one or more embodiments, the computer system 600 takes the form of the application server 122 described above in FIG. 1, the identity resolution server described above in FIGS. 2 and 5, or takes the form of any other server or other computer including a processor and memory. In one or more embodiments, the computer processor(s) 670 takes the form of the processor 500 described in FIG. 5.

In one or more embodiments, the repository 602 may be any type of storage unit and/or device (e.g., a file system, database, collection of tables, or any other storage mechanism) for storing data. Further, the repository 602 may include multiple different storage units and/or devices. The multiple different storage units and/or devices may or may not be of the same type or located at the same physical site. The repository 602 may include a data retrieval service 604, a graph analysis system 106, and a campaign configuration service 608.

At runtime, a data retrieval service 604 may receive a data request (e.g., an identity resolution job) from the application server and/or client device. The data request may be received and processed in real time in order to dynamically resolve target identifiers for a variety of source identifiers for use in in programmatic online advertising. For example, the data request may be received from a supply side portal (SSP) connected to a digital ad exchange. The SSP may identify one or more source identifiers in bidstream data published by the digital ad exchange. For example, the SSP may identify one or more cookie ids in the bidstream data for an ad network managed by the digital ad exchange. The bidstream data may include the cookie ids for cookies installed on browsers accessing webpages or the websites within the ad network. The SSP may generate a data request including the source ids extracted from the bidstream and one or more target id types that are consumed by one or more demand side portals (DSPs) connected to the ad exchange. The data retrieval service 106 may generate one or more pieces of identity data (e.g., identifiers, identity records, identity graphs, and the like) that include identifiers of the target id type for the source ids in the data request. The data retrieval service 106 may distribute the identity data to the DSP, SSP, or other computer system connected to the digital ad exchange to enrich the bidstream data and facilitate more efficient transactions on the digital ad exchange and better advertising experiences for users that access the webpages within the ad network.

The data request received by the data retrieval service 604 may include a list of source ids and a target id type. The graph analysis system 106 may determine a response for the data request by using a unified query service 230 to extract one or more identity records from one or more of the identity spaces 622A, . . . , 622N included in the identity data 620. The identity records may be linked to each of the source ids and may include at least one identifier having the target id type. A graph constructor 620 may combine the identity records into an identity subgraph 660 that includes one or more identity clusters 662A, . . . , 662N. The identity clusters 662A, . . . , 662N may be graph structures that store identifiers 624, identity attributes 626, and other pieces of identity data extracted from the identity records as nodes and the relationships between the identifiers 624, identity attributes 626, and other identity data as edges.

In various embodiments, a campaign configuration service 608 may use the identity subgraphs 660 to configure one or more media campaigns. For example, the campaign configuration service 608 may determine targeting data based on the identity data and relationships included in the identity clusters 662A, . . . , 662N. The campaign configuration service 608 may use the targeting data to select users for a target audience that receive one or more pieces of media campaign content (e.g., lines of text, images, articles, webpages, websites, emails, display ads, text messages, linear tv ads, segments of streaming video, video game components, virtual reality media, and the like). The publishing engine 680 may run the media campaign by distributing media campaign content to the users of the target audience using one or more identifiers 624 included in the identity subgraphs 660. For example, the publishing engine 680 may send emails to a list of email addresses included in one or more of the identity clusters 662A, . . . , 662N including identity data of users in the target audience. Similarly, the publishing engine 680 may display an ad image on browser clients having a cookie ids included in one or more identity clusters 662A, . . . , 662N of an identity subgraph 660 storing identity data of users in the target audience.

To determine responses for data requests, the graph analysis system 106 may access identity data 620 stored in multiple data sources. Identity data 620 may include millions and/or billions of unique identity records that reside in different databases hosted by different datastores. For example, the graph analysis system 106 may access identity data 620 stored in multiple different database types (e.g., graph databases, relational databases, unstructured databases, and the like) that may each have different data structures (e.g., graphs, tables, unstructured files, and the like) The databases including identity data 620 may be persisted in multiple different datastores (e.g., Hive, Scylla, Snowflake, and the like) that each have different schemas and provide different sets of metadata.

Within each database, the identity data 620 may distributed across multiple identity spaces 622A, . . . , 622N that each include a unique collection of identity records for an entity (e.g., user, device, organization, and the like).

The identity records may include record identifiers (IDs) 624 and identity attributes 626 that provide more information about users associated with a particular identifier 624. Each of the identity spaces 622A, . . . , 622N may include different collections of identifiers 624 and identity attributes 626. The identifiers 624 may have different identifier types, for example, first name, last name, postal address, email address, mobile device ids (MAIDs), connected television device ids (CTVIDs), IP addresses, cookies, and the like. The identity attributes 626 may include one or more characteristics for a user, device, or other entity associated with an identifier. For example, identity attributes 626 may include one or more pieces of user data (e.g., location data, demographic data, device metadata, machine learned attributes, interest codes, and the like), event data (e.g., impressions and other engagement data, and the like) and transaction data (purchase records, purchase amounts, transaction metadata, and the like) associated with a user linked to an identifier 624. The identity spaces 622A, . . . , 622N may include different sets of identifiers 624 and identity attributes 626 for different collections of users. For example, one identity space (e.g., a first party customer database of a brand) may include a first set of identifiers (first name, last name, postal address, and email address) and a first set of identity attributes (e.g., purchase records and purchase amounts) for a population of customers of the brand. A second identity space (e.g., a third party identity graph of a customer data platform) may include a second set of identifiers (e.g., postal address, MAID, and browser cookie) and a second set of identity attributes (e.g., demographic data, webpage impressions, and email open events) for a population of the customers of brands that partner with the customer data platform. The first and second identity spaces may be linked by one or more linking identifiers (e.g., postal address) that are found in both identity spaces.

A data ingestion service 220 may map each of the identity spaces 622A, . . . , 622N to generate mapping data 632. The unified query service 230 may use the mapping data 632 to generate unified queries that may be used to retrieve identity records from any of the identity spaces 622A, . . . , 622N regardless of the location (e.g., database or datastore), data structure, and type of identity records and/or identifiers included in the identity space. The unified query framework may include a series of three or more APIs that may be used to determine one or more steps 643, paths 646, and resolution schemes 648 to include in unified queries 640A, . . . , 640N. For example, a unified query framework implemented by the unified query service 230 may include a step API that determines one or more steps 643 based on mapping data 632, a path API that determines one or more paths 646 based on the steps 643, and a resolution scheme API that determines one or more resolution schemes 648 based on the paths 646.

To determine mapping data 632 for the identity spaces 622A, . . . , 622N, the data ingestion service 220 may retrieve a database type and step metadata for each identity space from the hosting datastore. The step metadata may include, for example, schemas for the identity spaces 622A, . . . , 622N that lists the identifiers, identifier types, identity attributes, and/or identity attribute types that may be included in each identity space. The data ingestion service 220 may use the step metadata to determine mapping data 632 for the identity spaces 622A, . . . 622N. The mapping data 632 may include a list of all of the identity spaces 622A, . . . , 622N and the types of identifiers 624 included in each of the spaces. The mapping data 632 may also include relationships between the identity spaces 622A, . . . , 622N and identifiers 624 and relationships between different identifiers 624 in each of the identity spaces 622A . . . , 622N. For example, the mapping data 632 may indicate all of identifiers 624 in an identity space 622A that are linked to a common identifier.

At runtime, the unified query service 230 may use the mapping data 632 to determine a set of steps 643 that are used respond to a data request. The steps 643 may identify an identity space 622A that has relationships between two or more identifiers 624 (e.g., a relationship between one or more source ids and one or more target ids included in a data request). For example, steps 643 may identify an identify space 622A having identity records for the same user, the same device, or other entity that includes two or more different identifiers. The steps 643 may include one or more configurable aspects such as a step name that specifies the identifier types (id types) for the identifiers 624 that are associated in the identity space 622A, an id space name (e.g., “space_name) that identifies the identity space 622A storing the associated record ids, a time period for lookup (e.g., “ttl”), and a datastore that persists the id space 622A (e.g., “datastore”). Example steps for identity spaces 622A, . . . , 622N including a “cookie-cookie” relationship and “cookie-email_md5” relationship are included below:
“cookie-cookie”: {“ttl”: 180, “datastore”: “hive”,
“space_name”:
“datacloud_cookie_cookies_relations_links_export”}
“cookie-email_md5”: {“ttl”: 180, “datastore”:
“hive”, “space_name”:
“datacloud_cookie_emails_links_export”}

The “cookie-cookie” step identifies an identity space (e.g., the “datacloud_cookie_cookies_relations_links_export” table) in the hive datastore that includes a relationship between two or more cookie type record ids. For example, the “cookie-cookie” step may refer to an identity space that includes two or more unique cookies for the same user, device, and/or entity (e.g., includes identity records having two or more cookies). The identity space identified by the “cookie-cookie” step may be used to resolve a cookie target id type for a list of source ids included in a data request by locating identity records including a cookie id that matches a cookie id in the source id list and extracting another cookie id (e.g., a second cookie id linked to the source id) from the located identity records.

The “cookie-email_md5” step identifies an identity space (e.g., the “datacloud_cookie_emails_links_export” table) in the hive datastore that includes a relationship between one or more cookie type record ids and one or more email type record ids. For example, the “cookie-email_md5” step may refer to an identity space that one or more cookie ids and one or more email_md5 ids for the same user, device, and/or entity (e.g., include identity records having one or more cookie id type identifiers and one or more email_md5 type identifiers). The identity space identified by the “cookie-email_md5” step may be used to resolve an email_md5 target id type for a list of cookie id type source ids by locating identity records including a cookie id that matches a cookie id in the source list and extracting an email_md5 id (e.g., an email_md5 id linked to the source id) from the located identity records.

The configurable aspects of the of steps 643 enable the unified query service 643 to search all of the identity spaces 622A, . . . , 622N that have been mapped by the data ingestion service 220 and are available to the client device and/or application server submitting the request. The step API may be configured to dynamically determine the available steps that may be used to generate responses to data requests based on the identity spaces 622A, . . . , 622N that are available to the client device and/or application server submitting the request. For example, some client devices may not have access to particular identity spaces due to geographical boundaries, varying access and usage boundaries (e.g., client device may be operated by users that do not have a subscription to certain identity spaces), and/or technical limitations (e.g., limited network bandwidth, memory resources, compute resources, response time requirements, and the like). The step API may filter out or determine not generate steps for identity spaces that the client device/application server does not have access to in real time when each data request in processed in order to tune the sets of steps generated to the characteristics and requirements of each client device and/or application server submitting a data request. The configurable aspects of the steps 643 also enable the unified query service 230 to automatically (e.g., without requiring modifications to the step API code) incorporate new and/or updated identity spaces and/or new datastores into the unified query framework. The unified query service 230 may make the identity data 620 in new and/or updated identity spaces and/or datastores available for search by generating steps 643 for the new and/or updated identity spaces based on new and/or updated mapping data 632 determined by the data ingestion service 220.

The unified query service 230 may use the steps 643 to determine paths 646 that may be used to retrieve identity records from multiple identity spaces 622A, . . . , 622N. The paths 646 may include direct paths from a first id to a second id that are within the same identity space. The paths 646 may also include indirect paths that link a first id to a second id via one or more hops between identity spaces. Some examples of direct and indirect paths are shown below:
“cookie-cookie”: {“source_id_type”:
“cookie”, “target_id_type”: “cookie”, “path_steps”: [“cookie-cookie”]}
“cookie-email_md5”: {“source_id_type”:
“cookie”, “target_id_type”: “email_md5”, “path_steps”:
[“cookie-email_md5”]}
“cookie-cookie-email_md5”: {“source_id_type”:
“cookie”, “target_id_type”: “email_md5”, “path_steps”:
[“cookie-cookie”, “cookie-email_md5”]}
“cookie-email_md5-email_md5”: {“source_id_type”:
“cookie”, “target_id_type”: “email_md5”, “path_steps”:
[“cookie-email_md5”, “email_md5-email_md5”]}

The “cookie-cookie” path is a direct path from a first cookie id to a second cookie id within the same identity space. The “cookie-cookie” path may be used to determine multiple cookie ids of the same user, device, and/or entity. For example, the “cookie-cookie” path may be used to locate an identity record for a user using a first cookie id (e.g., a source cookie id) and identify, in the located identity record, the other cookie ids linked to the user. The “cookie-email_md5” path is a direct path from a cookie id to an email md5 id within the same identity space. The “cookie-email_md5” path may be used to determine an email md5 id for a user, device, or entity having a particular cookie id. For example, the “cookie-email_md5” path may be used to locate an identity record for a user using a cookie id (e.g., a source cookie id) and identify, in the located identity record, an email md5 id for the user.

The “cookie-cookie-email_md5” path is an indirect path from a cookie id to an email md5 id that traverses between two identity spaces. The indirect path includes a hop between the identity spaces represented by each of the two steps 643 included in the path 646 (e.g., “cookie-cookie”, “cookie-email_md5”). The first step (e.g., the “cookie-cookie” step) is used to identify identity records that include multiple cookies ids (e.g., the source cookie id and one or more other cookie ids) associated with a user, device, or entity. The second step (e.g., the “cookie-email_md5” step) is used to identify identity records that include an email md5 address of the user, device, or entity. For example, the “cookie-cookie-email_md5” path may use a source cookie id to locate, in a first identity space, an identity record for a user that includes multiple cookie ids. The “cookie-cookie-email_md5” path may query a second identity space using the multiple cookie ids to locate one or more identity records including an email md5 of the user. By using common ids (e.g., the cookie ids) to link identity records in multiple identity spaces, the “cookie-cookie-email_md5” path may be used to resolve an email md5 id for a source cookie id even though no single identity record includes both identifiers.

The “cookie-email_md5-email_md5” is an indirect path from a cookie id to an email md5 id that traverses between two identity spaces. The indirect path includes a hop between the first and second identity spaces included in the path 646 (e.g., “cookie-email_md5”, “email_md5-email_md5”). The first step (e.g., “cookie-email_md5”) is used to identify identity records including one or more email md5 ids associated with a user, device, or entity. The second step (e.g., “email_md5-email_md5”) is used to identify identity records that include multiple email md5 ids for the user, device, or entity. For example, the “cookie-email_md5-email_md5” path may use a source cookie id to locate, in a first identity space, an identity record for a user that includes an email md5 id. The “cookie-email_md5-email_md5” path may query a second identity space using the email md5 id from the first identity space to locate identity records that include other email md5 ids for the user. The unified query service 230 may use the paths API to determine paths 646 that include hops between three or more identity spaces. The number of hops and identity spaces included in the set of paths 646 for each data request depends on the available identity spaces 622A, . . . , 622N and the most efficient way to use the available spaces to extract the target identity data for the source ids specified in the data request.

To determine the paths 646 for a unified query 640A, the path API may determine a set of target identity spaces (e.g., available identity spaces that include identifiers of a target id type specified in a data request). The path API may use the steps 643 determined by the step API to map the links between each target identity space and the other available identity spaces. The step API may construct, based on the mapping, a sequence of steps that link each target identity space to a source identity space (e.g., an entity space that includes identifiers having a source id type included in the data request). The step API may assemble the step sequences into paths 646 so that each path includes a unique sequence of steps.

The paths 646 may include one or more configurable components including a source id type (“source_id_type” in the examples above) that specifies a type of identifier for a list of source ids included in a data request, target id type (“target_id_type” in the examples above) that specifies a type of identifier to be retrieved for each source id, and paths (“paths” in the examples above) that list all possible step sequences to get from a source identity space to a target identity space. The configurable aspects of the paths 646 enable the unified query service 230 to incorporate additional source and/or target id types into the unified query framework without modifications to the steps API code. The configurable source and target id types of the paths 646 expands the number of source and target id types supported by the unified query service 230 and makes the unified queries 640A, . . . , 640N more specific and customizable. Users may use the unified query service 230 to extract only the specific subset of identity data they need for a particular application. By targeting specific sets of identity data, the unified query service 230 conserves processing time and resources relative to other techniques with hard coded target and/or source id types that require multiple queries to get the desired data and provide superfluous data in addition to the requested results.

The configurable aspects of the paths 646 also increase the flexibility of the unified query service 230 and reduces the amount of time required to retrieve identity data from new and/or updated identity spaces relative to techniques that rely on hard coded paths. The unified query service 230 may use the path API to dynamically determine the paths 646 in real time using the most updated set of steps 643 and mapping data 632. The path API may also dynamically limit the number of paths based on technical requirements (e.g., response time, lag time, maximum number of target identifiers included in each request response, maximum amount of compute, network, or memory resources consumed for each request response, and the like) of the client device/application server submitting the data request and or technical limitations of the unified query service 230. Dynamic adjustments made by the path API may enable the data retrieval jobs to run more efficiently and achieve a desired response time and/or desired number of target identifiers without consuming more compute, network, and/or memory resources than necessary.

The ability of the paths API to dynamically determine paths also enables the unified query service 230 to quickly and efficiently adjust to changes in one or more identity spaces and/or data sources to ensure stale or inaccurate identity data is not included in responses to data requests. The process of generating paths 646 dynamically based on dynamically determined steps also ensures the unified queries 640A, . . . , 640N reach every available identity space including identity spaces and/or data sources that were recently mapped by the data ingestion service 220. Query techniques that rely on hardcoded paths would have a delay between when new identity spaces and/or data sources are mapped and when the new identity spaces and/or data sources are available to query. The delay may correspond to the amount of time required to update the hardcoded paths based on the new mapping data. The unified query service 230 does not have this limitation because the steps API updates step data automatically based on new mapping data 632 (and/or generates steps dynamically for each data request) and the paths API determines paths dynamically at runtime, so it can incorporate the updated step data in real time to build unified queries 640A, . . . , 640 that can reach all newly added and/or updated identity spaces and/or data sources.

The unified query service 230 may determine one or more resolution schemes 648 that are used to retrieve identity records. The resolution schemes may tailor the identity records retrieved by the unified queries 640A, . . . , 640N for one or more applications to ensure identity subgraphs 660 including the retrieved identity records are optimized for the desired application. The resolution schemes 648 may include one or more resolution rules that may configure the data retrieval process. The unified query service 230 may modify one or more of the resolution rules based on a specific application, selection of available identity spaces, and/or data sources, source id type, target id type, and the like to generate an optimal resolution scheme 648 for a specific application (e.g., identity resolution, audience expansion, lead generation, and the like), user, and/or set of resource constraints. The resolution rules that may be configured by the unified query service 230 include matching priorities, linkage sources, linkage confidence score, links per identifier, paths, and a ruleset code. The unified query service 230 may determine unique resolution schemes 648 including different sets of resolution rules in order to produce identity subgraphs 660 intended for different use cases.

The matching priorities order the most preferred identifier types for the resolution scheme 648. The matching priorities may include an inter identity space matching priority that defines the order of the most preferred identifiers across all available identity spaces. During the data retrieval process, the unified query service 230 may locate identity records using ids having an identifier type with a higher matching priority first then locate records for the unresolved portion of the requested data using ids having identifier types with a lower matching priority. For example, if the resolution rules specify a matching tier priority of postal address, email md5, and cookie, the unified query service 230 will first retrieve identity records having a postal address that matches one of the source postal address ids. The unified query service 230 may then try to retrieve identity records for the unresolved portion of the source ids by searching for identity records having an email md5 id that matches one of the source email md5s. The unified query service may then use search for identity records having a cookie ids that matches one of the source cookie ids to try to retrieve identity records for the source ids that were not matched using the postal or email md5 ids.

Users may determine the matching tier priorities that best fit their application. The unified query service 230 may also determine a set of optimal matching priorities dynamically based on the source id type and/or target id type included in the data request and/or a specific application of the identity subgraph 660. For example, the unified query service 106 may determine postal addresses are higher confidence ids for postal address type source ids and/or audience expansion applications and, as a result, generate a unified query 640A having postal address as the highest matching priority. In another example, the unified query service may determine cookie ids have the highest reach for email md5 target ids and/or identity resolution applications and, as a result, may generate a unified query 640A having cookie id as the highest matching priority. The unified query service 230 may also determine optimal matching priorities based on the characteristics of the available identity spaces. For example, identifiers that are more common and/or have a greater number of unique values across the identity spaces may be given higher matching priorities to maximize the id resolution speed. The unified query service 230 may also determine optimal matching priorities based on the requirements of users of the client devices/application servers submitting data request. For example, identifiers that are linked to more desirable target identifiers for particular users (e.g., identifiers that are more commonly linked to email addresses for users wanting to send email campaigns) may be given higher matching priorities than identifiers that are more commonly linked to less desirable target identifiers.

To customize the unified queries 640A, . . . , 640N for different applications and/or identity spaces, the matching priorities may include an intra identity space matching priority that defines the order of the most preferred identifiers within an identity space. Not all identity spaces are equal, and tiering more precisely orders matching priorities to maximize the precision and/or reach of the data retrieval process. For example, some identity spaces may include identity records that are more reliable and/or more persistent. Cookie ids may be more reliable than postal address ids because cookies may be associated with a particular device and/or browser client used primarily by a one person and multiple people may live at the same address. On the other hand, postal address identifiers may be more reliable than email identifiers because people may have multiple email accounts but typically only live at one address. Inter identity space matching priorities increase the quality and/or reach of the retrieved identity records by allowing the unified query service 230 to prioritize the identifiers by reliability, persistence, availability, and the like.

Additionally, some identity spaces are flat (e.g., either have an identifiers or do not) and some are hierarchical in that the same identifier may be matched to identity records on multiple levels. For example, postal identifiers with names and addresses are hierarchical because they may be directly matched to ids that include an identical name and address and they also may be fuzzy matched using only the address or portion of the address (e.g., street name, zip code, and the like). The resolution rules may include intra identity space matching priorities to define the order of the most preferred matching priorities within a hierarchical identity space. For example, the intra identity space matching priories for an identity space including unhashed email ids may give the complete user address and domain (e.g., john@gmail.com) the highest matching priority and the domain (e.g., gmail.com) a lower matching priority. The intra identity space matching priorities ensure the requested identifiers will be matched to the complete email address first before fuzzy matching on the email domains. The resolution rules may order the matching priorities for identifiers based on the inter and intra id matching priorities. For example, the resolution rules may include a top matching priority for complete email ids, a second matching priority for name and address postal ids, a third matching priority for the street address portion of the postal ids, and a fourth matching priority for the domain portion of the email ids.

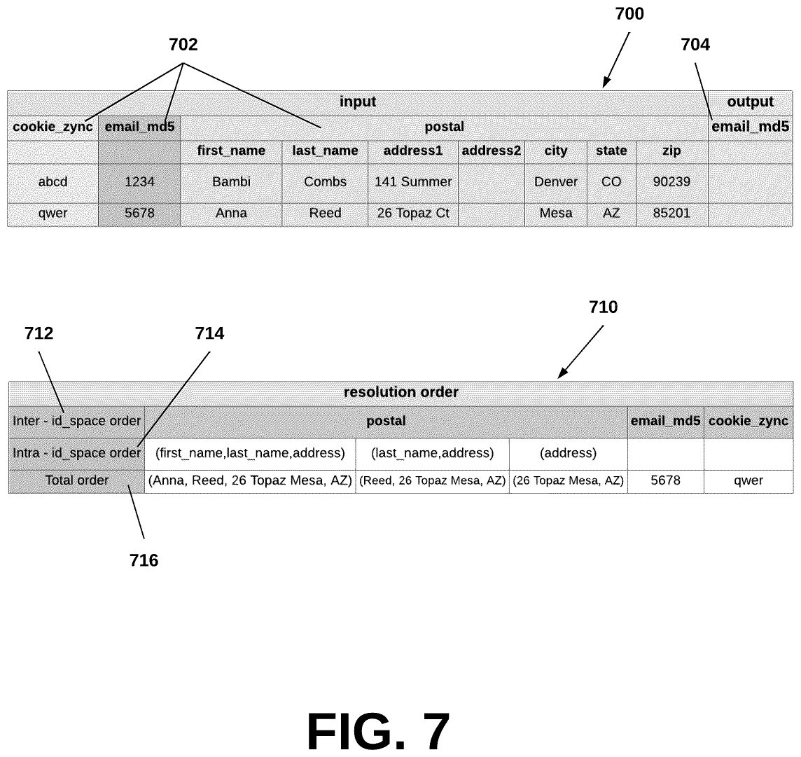

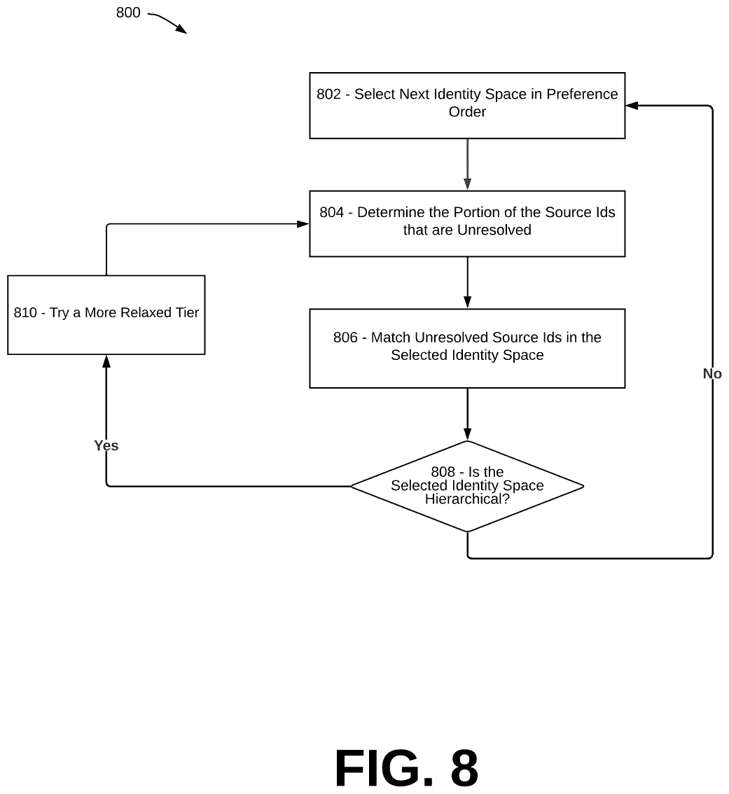

FIGS. 7-8 provide more details for a tiered matching approach that may be implemented by the unified query service using the inter and intra matching priorities. FIG. 7 illustrates an example data request table 700 including a set of input source ids 702 and an output target id type 704 for a data request. FIG. 7 also illustrates an example resolution order table 710 including a set of inter identity space matching priorities 712 and intra identity space matching priorities 714 for the identifiers included in the input source ids 702. The resolution order table 710 also shows a total order 716 for the combined intra and inter identity space matching priorities that will be reflected in the resolution rules of the resolution scheme used to retrieve identity records for the data request. The total order 716 specifies resolution logic that matches source ids to first_name, last_name, address postal ids first, then to last_name, address postal ids, then to address postal ids, then email_md5 ids, and last to cookie_zync ids.

FIG. 8 illustrates an example process 800 for retrieving identity records using resolution rules that implement the total order matching priorities shown in FIG. 7. At step 802 the unified query service selects the next identity space in the preference order (e.g., the first priority identity space in the total order, i.e., an identity space having postal ids). At step 804 the unified query service determines the portion of the source ids that are unresolved (e.g., all of the source ids in the data request because no source ids have been matched yet). At step 806, the unified query service matches the unresolved source ids in the selected identity space (e.g., attempts to match each source id in the data request to the top priority identifier in the top priority identity space, i.e., attempts to match source ids to first_name, last_name, address postal ids in the identity space having postal ids).

At step 808, the unified query service determines if the selected identity space is hierarchical. If the selected identity space is hierarchical (yes at 808), the unified query service may select a more relaxed tier, at step 810. The more relaxed tier may be determined based on the intra identity space matching priorities and the unified query service may fuzzy match identity records to the remaining unresolved source ids using the next identifier in the order by repeating steps 804 and 806. For example, the unified query service may attempt to match unresolved source ids to last_name, address postal ids. Steps 808 and 810 may be repeated until each tier in the selected identity space has been used to match source ids. For matching priorities that order lower tiers of higher priority identity spaces below top tiers of lower priority identity spaces steps 808 and 810 may be skipped and the process may proceed back to step 802 to begin locating identity records for any unresolved source ids using the next identity space in the preference order. If the selected identity space is not hierarchical (no at 808), the unified query service may select the next identity space in the preference order (e.g., for the total order of FIG. 7, an identity space having email_md5 ids), at step 802. Steps 804-808 may be repeated to locate identity records for an unresolved portion of the source ids in the selected identity space. For example, the unified query service may match email_md5 ids in the unresolve portion of the source ids to email_md5 ids in the new selected identity space. Steps 804-808 and optionally step 810 may be repeated to match unresolved source ids on the next highest priority identity space until all of the available identity spaces have been searched and/or all of the source ids have been resolved (e.g., identity records have been located for all of the source ids).

Referring back to FIG. 6, the resolution rules may also include one or more linkage sources (e.g., identity spaces and/or data sources) to exclude and/or include from the data retrieval process. Linkage sources that are excluded by the resolution rules are not queried by the unified query service 230 and linkage sources that are included by the resolution rules are added the available linkage sources that are queried by the unified query service 230. Making the available identity spaces and/or linkage sources configurable aspects of the resolution schemes 648 provides greater customization of unified queries 640A, . . . , 640N to give users more control over the data retrieval process. For example, one or more permissioned and/or paid identity spaces and/or data sources may be excluded by the resolution rules for data retrieval jobs for users that do not pay for or have access permissions for a particular identity space and/or data sources. Users may select one or more linkage sources to exclude or include. The unified query service 230 may also dynamically determine available linkage sources for each data request, at runtime, to generate custom unified queries for each user and/or data request.

The dynamic system of determining available linkage sources is a significant improvement over hard coded, static libraries of linkage sources that offers several advantages. For example, the dynamic system of determining available linkage sources may enable the graph analysis system 106 to quickly adapt the query experience to updates in data protection, information security, and/or privacy regulations that may restrict access to certain types of data for certain users. The dynamic system of determining available linkage sources may also enable the graph analysis system 106 to provide a custom query experience for each user by, for example, providing different query experiences for users in different geographic locations, users in different payment and/or usage tiers, users in different industry verticals, and the like.

To provide even greater customization of the unified queries 640A, . . . , 640N, the paths 646 may also be configured in the resolution rules to exclude one or more paths from the data retrieval process. Paths 646 that are excluded by the resolution rules may not be queried by the unified queries 640A, . . . , 640N. User may select one or more paths 646 to exclude. The unified query service 230 may also dynamically determine the paths 646 to exclude for each data request, at runtime, to optimize the data retrieval process for one or more constraints. For example, the unified query service 230 may exclude paths that include one or more identity spaces that exceed a maximum size (e.g., 1 TB or any other specified number) for data requests having a run time constraint (e.g., must return results within 5 mins or any other specified time period) and/or resource constraint (e.g., retrieval job must cost less than $0.10 or some other specified amount to complete, retrieval job must consume less than 5 CPU credits or consume less than some other amount of compute and/or memory resources, and the like).

One or more resolution rules may also be used to customize the identity subgraphs 660 produced using the identity records retrieved by the unified query service 230. For example, the resolution rules may define a max number of links per identifier to limit the size of the identity subgraphs 660. The max number of links per identifier may cap the number of identity records that can be retrieved for a particular id type. For example, the resolution rules may limit the number of maid ids, email ids, cookie ids, and the like to a predetermined number of identity records for each id type (e.g., 5, 10, and 7, respectively). If a source id matches to a number of identity records for a specific id type (e.g., email_sha256) that exceeds the number of max links per identifier, the graph query service 230 will select a number of the top identity records (e.g., records from higher confidence and/or higher priority identity spaces) that match the number of specified max links per identifier and discard the remaining identity records from the retrieved datasets.

The resolution rules may also include a minimum id confidence score for each identity record. The minimum id confidence score may be used to ensure subgraphs 660 include the highest quality identify records. The graph query service 230 may determine a confidence score for each identity record based on the identity space and/or datasource including the identity record, the age of one or more identifiers included in the identity record (e.g., time period elapsed since an event confirming the identifier linked to a user), the type of identifier, and the like. The graph query service 230 may determine higher id confidence scores for identity records that were recently linked to users, for example, an email md5 for an email account that recorded an open event within the last 3 days, and/or are stored in high confidence identity spaces. Identity records that have high matching priorities may also receive higher id confidence scores. The graph query service 230 may determine lower id confidence scores for identity records that were not recently linked to users (e.g., have record no linking events for the past month) and/or are from low confidence identity spaces. Identity records having identifiers with lower matching priorities (e.g., second or third tier identifiers used for fuzzy matching in hierarchical identity spaces) may also receive lower confidence id scores.

The id confidence scores for identity records retrieved by the unified query service 230 may be compared to a minimum id confidence score included in the resolution rules. Identity records having id confidence scores that are below the minimum id confidence score may be executed from the retrieved datasets. A filtering module 234 included in the graph constructor 620 may also filter one or more identity records based on one or more resolution rules. For example, the filtering module 234 may filter identity records based on the max links per identifier and/or minimum id confidence scores to remove identity records from the datasets retrieved by the unified query service 230 that exceed the number of max links per identifier and/or have confidence scores below the minimum id confidence score. The filtering module 234 may remove the additional and/or low confidence identity records from the datasets before the subgraphs 662A, . . . , 662N are constructed in order to simplify the operations of the graph constructor 620 and improve the quality of the identity data included in the subgraphs 662A, . . . , 662N.

The graph constructor 620 may build one or more identity subgraphs 660 using the datasets of identity records retrieved by the unified query service 230 and, optionally, filtered by the filtering module 234. The subgraphs 662A, . . . , 662N may include one or more identity clusters with each cluster including one or more identifiers and/or identity attributes for a user or other entity. Each identity cluster may include a unified id created by the graph constructor 620 to identify the cluster and the identifiers linked to the unified id that are extracted from the identity records retrieved by the unified query service 230. The graph constructor 620 may generate the unified ids using a rule set code included in the resolution rules. The rule set code may define an alpha numeric prefix that may be included at the beginning of each unified id. The graph constructor 620 may determine a unified id for each identity cluster by selecting an identifier from one of the retrieved identity records (e.g., the identifier with the highest matching priority) and appending the prefix of the rule set code to the selected identifier. The graph constructor may also generate a new identifier (e.g., by using a random number generator) for the user or other entity and appending the rule set code prefix to the new identifier to create the unified id.

The subgraphs 660 may also include one or more identity attributes that may be linked on one or more identifiers. The identity attributes may be extracted from the identity records retrieved by the graph query service 230 and may provide additional information about the linked identifier and/or user or other entity of the identity cluster. The identity attributes may be used to filter identity subgraphs to identify a segment of users to target in a media campaign. The identity clusters for each user in the identified segment may be used to configure one or more media campaigns.

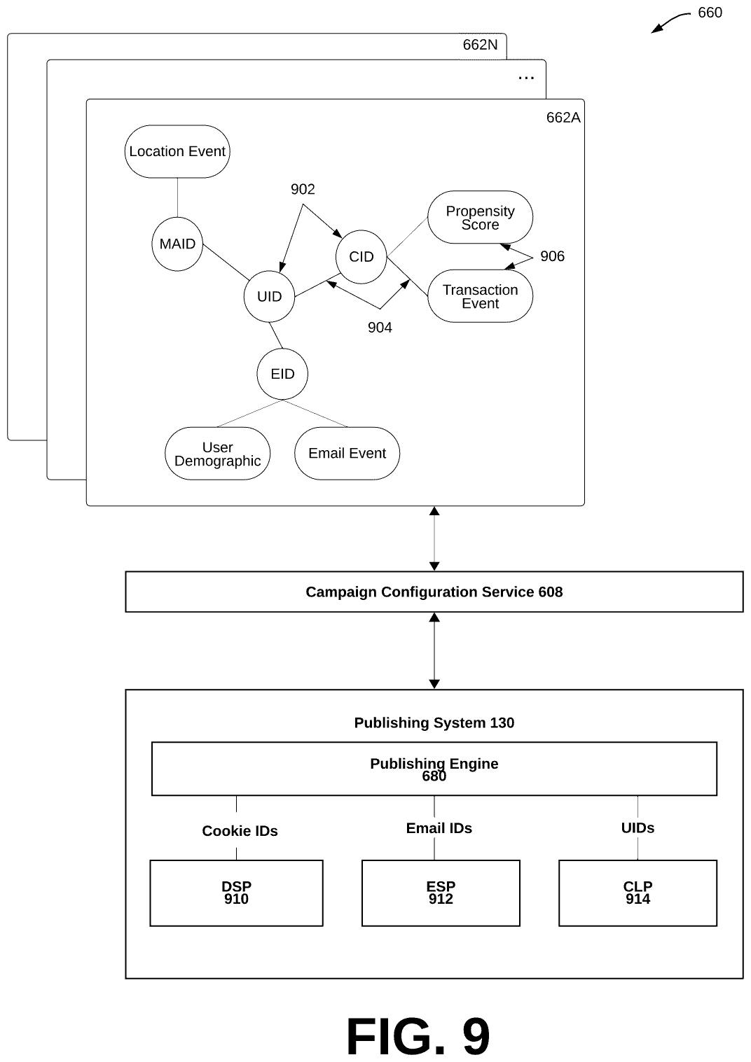

FIG. 9 illustrates an example identity subgraph 660 and a system for using the identity clusters 662A, . . . , 662N to configure one or more media campaigns. The identity clusters 662A, . . . , 662N may be graph structures that include multiple nodes and one or more edges 904 connecting the nodes. The identity clusters 662A, . . . , 662N may include a set of identity data included in the identity records retrieved by the unified query service. The graph constructor may build an identity cluster 662A for each user having one or more identity records retrieved by the graph query service so that each of the identity clusters 662A, . . . , 662N includes identity data for a unique user. The graph constructor may also build identity clusters 662A, . . . , 662N that include identity data for multiple users (e.g., an audience of selected users). The nodes in an identity cluster 662A may include identifier nodes 902 that represent identifiers associated with the user and/or users that were included in the identity records retrieved by the graph query service. For example, the identifier nodes 902 in identity cluster “A” 662A may include a unified id (“UID”), device id (“MAID”), cookie id (“CID”), and email id (“EID”). The nodes may also include attribute nodes 906 connected to one or more of the identifier nodes 902 that represent one or more identity attributes of a user represented by the identity cluster 662A. For example, the MAID identifier node may be connected to a location event attribute node that provides a location of a device associated with a MAID identifier. The CID identifier node may be connected to a propensity score attribute node that represents a likelihood the user associated with the CID identifier would buy a particular type of product and/or purchase from a particular brand. The CID identifier node may also be connected to a transaction event attribute node that represents a transaction (e.g., a purchase transaction) completed by a user associated with the CID identifier. The EID identifier node may be connected to a user demographic attribute node that represents one or more demographic traits (e.g., age, gender, income level, marital status, ethnic origin, income level, education level, occupation, and the like) of a user associated with the EID identifier. The EID identifier node may also be connected to an email event attribute node that represents an email event (e.g., a delivery, open, click, conversion, and the like) performed by a user associated with the EID identifier. The graph constructor may include different types of nodes in the identity clusters 662A, . . . , 662N to represent different types of information that were included in the identity records.

The edges 904 connecting the nodes may represent one or more relationships between the nodes. For example, the edges 904 between the UID identifier node and the MAID, CID, and EID identifier nodes connect the nodes to show a common relationship between each of the nodes (e.g., all of the identifier nodes are associated with the same user). The edges 904 between the transaction event attribute node and the CID identifier nodes connect the nodes to show that the transaction event data and CID identifier were included in the same identity record. The graph constructor may include different types of edges 904 in the identity clusters 662A, . . . , 662N to show different types of relationships between the nodes. For example, an edge represented by a dashed line may be included to represent an indirect linkage between two or more identifiers and/or different tiers of identifiers within a hierarchical identity space.

The identity clusters 662A, . . . , 662N may include identity information extracted from multiple identity spaces. For example, the identity cluster 662A may include CID identifiers, propensity scores, and transaction events from a cookie identity space. The MAID identifiers and location events may be from a device identity space. The EID and email events may be from an email identity space and the user demographic traits may be from a demographic identity space. The graph constructor may use the resolution rules included the resolution scheme of each query to determine the subset of identifiers and identity attributes of the retrieved identity records to include as nodes identify clusters 662A, . . . , 662N. The graph constructor may also use the resolution rules to determine the relationships between the different identity spaces, identifiers, and identity attributes included in the identity records required to draw the edges of the identity clusters 662A, . . . , 662N.

The identity clusters may be used to configure one or more media campaigns running on the publishing system 130. For example, the identity clusters 662A, . . . , 662N may be used to identity and reach members of a target audience. To identity the users of a target audience, the campaign configuration service 608 may query the identity clusters 662A, . . . , 662N using one or more identities and/or identity attributes. For example, the campaign configuration service 608 may query the identity clusters 662A, . . . , 662N to identify the clusters for users that are reachable by email (e.g., include an EID) that have a high propensity for purchasing athletic shoes (e.g., include a propensity score for athletic shoes of above 0.75). To run a media campaign targeting users of the target audience for athletic shoes, the campaign configuration service 608 by extract a CID, EID, and/or UID from the identified clusters and provide the extracted identifiers to a publishing system 130. A publishing engine 680 operated by the publishing system 130 may run the campaign by providing the extracted CIDs to a DSP 910 configured to purchase media placements served on webpages downloaded by clients (e.g., browsers) and/or devices running cookies having one of the extracted CIDs. The publishing engine 680 may also provide the extracted EIDs to an ESP 912 configured to compose and send email messages having campaign media to email accounts having one of the extracted EIDs. The publishing engine 680 may also provide UIDs to a cookie-less publishing platform (“CLP”) 914 configured to obtain media placements served on webpages accessed by users having one of the extracted UIDs.

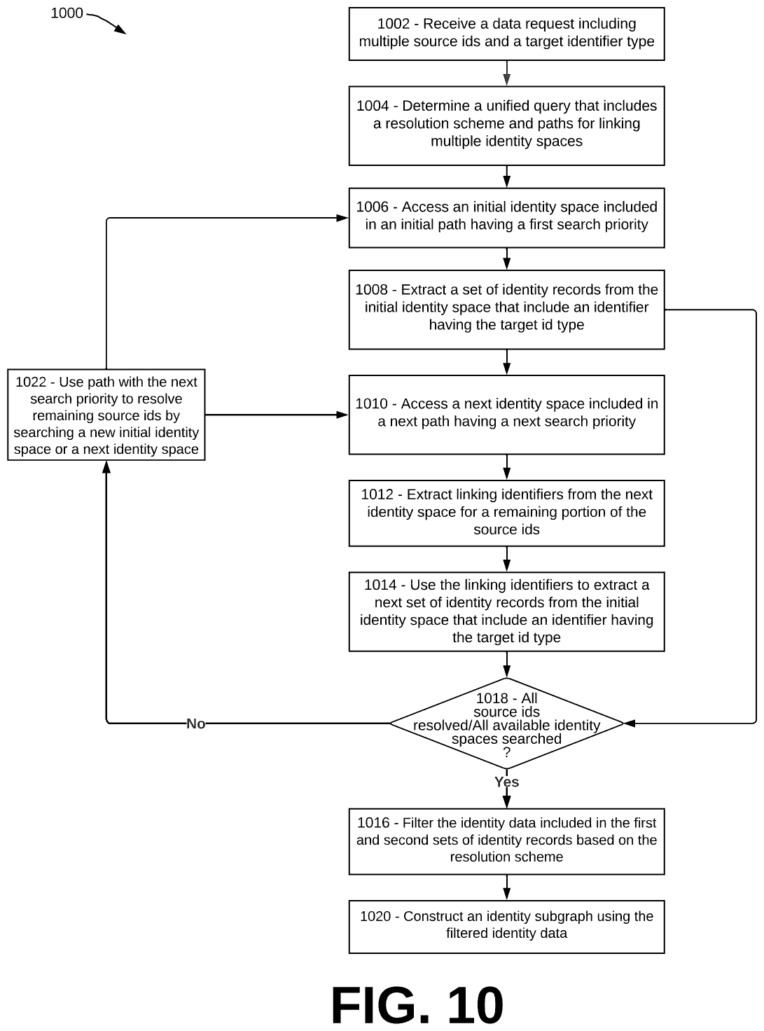

Some present examples also include methods. FIG. 10 is a block diagram of a process 1000 of generating identity subgraphs. At step 1002, the identity resolution server receives a data request from an application server and/or client device. The data request may include multiple source ids and a target identifier type for the target ids to be resolved for each source id. A graph analysis system of the identity resolution server may respond to the data request by locating and extracting identity records from multiple identity spaces that include identity data that may be used to resolve one or more target identifiers of the target id type for each of the source ids.

At step 1004, a graph query service of the graph analysis system may begin resolving the target identifiers for the source ids by determining a unified query that may be used to search multiple, asymmetric identity spaces for identity records that include the requested target ids. The unified query may include one or more steps, one or more paths, and a resolution scheme. The steps may be determined using a step API and may include a unique step for every available identity space that may be used to retrieve one or more of the target ids. The paths may be determined using a path API and each path may include one or more step sequences that may link multiple identity spaces.

The paths may include direct paths that link two or more identifiers included in the same identity space. The paths may also include indirect paths that link two or more identifiers that are included in different identity spaces. The indirect paths may include one or more identifier types for linking identifiers that are present in at least two of the identity spaces included in an indirect path. The linking identifiers may link the identity spaces to enable the unified query to search the identifiers included in all of linked identity spaces of the target ids. For example, the unified query service may create a DataFrame or other data structure that joins multiple identity space tables on a set of linking ids so that identity data for the same identifier may be extracted from each identity space. Similarly, the unified query service may create a GraphFrame or other data structure that joins multiple identity space graphs by performing a grid search for a set of linking ids. In paths that include two or more steps (e.g., indirect paths), the identity spaces represented by each pair of consecutive steps may include an identifier type for one or more linking identifiers that appear in both identity spaces. For example, in the set of paths:
Path1: cookie-email_md5
Path2: cookie-cookie, cookie-email_md5
Path3: cookie-email_md5, email_md5-email_md5
Path4: cookie-cookie, cookie-email_md5, email_md5-email_md5
   a cookie id type of identifier is used to link the identity spaces represented by the “cookie-cookie” and “cookie-email_md5” steps in Path2. Similarly, an email md5 id type of identifier is used to link the identity spaces represented by the “cookie-email_md5” and “email_md5-email_md5” steps in Path3. Accordingly, the linking identifiers that may be used to link the identity spaces of Paths 2 and 3 are cookie ids and email md5 ids, respectively.

To improve the speed and efficiency of the unified query service, one or more identity spaces may be stored in a cache memory of the identity resolution server. The unified query service may store, in cache memory, one or more identity spaces that are searched multiple times in the identity record retrieval process. The unified query service may determine the identity spaces to store in cache memory dynamically for each data request at runtime based on the paths included in the unified query. The unified query service may determine the identity spaces that are searched multiple times based on the number of times the identity spaces appear in the paths of a unified query. For example, the unified query search may determine identity spaces that appear in the step sequences of two or more paths are searched multiple times during identity record retrieval (e.g., once for each path) and may be stored in memory cache. Caching identity spaces that are read multiple times during data retrieval improves the efficiency of the identity resolution server by enabling the identity resolution server to read each identity space once during identity record retrieval instead of multiple times (e.g., each time a path including the identity space is used to retrieve identity records). Accordingly, caching one or more identity spaces reduces the amount of processing time and resources required to access and read the cached identity spaces from the database server. In the example paths above, the identity spaces represented by the “cookie-email_md5”, “cookie-cookie”, and “email_md5-email_md5” steps may be stored in cache memory so these identity spaces may be read from the database server once instead of 4, 2, and 2 times, respectively.

In various embodiments, one or more identity spaces may be too large to store the entire identity space in cache memory. For example, the identity space represented by the “cookie-cookie” step may have a size that exceeds a maximum caching threshold (e.g., 100 million rows, 100 million nodes, 500 million rows, 500 million nodes, 500 megabytes (MB), 1 gigabyte (GB), or any other predetermined table size). Storing identity spaces that exceed a maximum caching threshold may consume too much of the available memory of the identity resolution server resulting in a failure of the data retrieval job (e.g., a failure caused by a lack of available memory for other operations) or an increase in cost of the job (e.g., an increase in cost caused by a dynamic scaling of available compute resources that obtains more memory resources to provide free memory for other operations). To ensure the reliability of the unified query service and minimize the cost of data retrieval jobs, large identity spaces may be intelligently cached.

Identity spaces that exceed a maximum caching threshold may be intelligently cached by storing portions of the identity spaces that are relevant to a data request in cache memory. For identity spaces having a table structure, an intelligent caching operation may store, in cache memory, a left join of the identity space table on a set of input data (e.g., source ids, linking ids, and the like). For example, an intelligent caching operation for the identity space represented by the “cookie-cookie” step may store the left join of the “cookie-cookie” identity space table on the set of cookie ids included in the source ids. This intelligent caching operation would store the portion of the “cookie-cookie” identity space table having identity records that include one of the source ids (e.g., the rows that may be located by searching the identity space table on the source ids). For identity spaces having a graph structure, an intelligent caching operation may store the portion of the graph connected to one or more nodes that include a set of input data. For example, the intelligent caching operation for the graph identity space represented by “cookie-cookie” step may search the “cookie-cookie” graph (e.g., by using a grid search algorithm) to select the nodes including a source id and the nodes connected on one or more of the source id nodes and store the selected source id and connecting nodes in cache memory. The remaining portion of the identity space that is not related to the input data may be discarded to reduce the amount of the identity space that is cached and preserve some of the memory resources for other operations required to retrieve identity records for the data request.

Including multiple paths in the unified queries expands the reach of the data retrieval job to identity spaces that are not directly linked to the source ids. To maintain the quality and accuracy of the identity records retrieved by the unified query service, the resolution scheme may include one or more resolution rules that define the matching priorities for the identifiers included in each of the paths. The unified queries may use the paths having the identifiers with the highest matching priorities to search identity spaces with the highest confidence target ids. To maximize the quality of the identity records that are retrieved by each data request, the unified query service may dynamically determine the matching priorities for each data request based on the target id type. The unified query service may determine a search priority for each of the paths included in the unified queries based on the matching priorities for the identifiers included in each path. The search priorities for the paths and the matching priorities for the identifiers may be included in the unified queries to ensure the unified query service searches the one or more identity spaces having identifier types included in the path with the highest search priority first before searching identity spaces with identifier types included in the paths have next search priorities.

At step 1006, the unified query service may access an initial identity space (e.g., a first identity space) accessed via a path (e.g., a first path) having a first search priority. The first identity space may include identifiers having an identifier type that matches each of the identifier types named in the first step of that highest search priority path. The location data of the first identity space (e.g., datastore and graph name, table name, and the like) may be determined from the step data for the first step generated by the steps API. When the unified query is executed, the unified query service used the location data for steps in the highest search priority path to access the first identity space.

The first identity space may include one or more lookup identifiers that match the identifier type for a source id that has the highest matching priority in the resolution scheme. For example, a data request may include cookie ids, postal ids, and email ids as source ids and email ids as a target id. The unified query service may determine matching priorities for the source ids are 1 for cookie ids (highest matching priority), 2 for postal ids (next highest matching priority), and 3 for email ids (lowest matching priority). Accordingly, the lookup identifiers may be cookie ids and the first identity space may include cookie ids and email ids (e.g., the identifier types named in the direct “cookie-email” path). The step data for the cookie-email step may be used to locate and access the first identity space to retrieve one or more identity records.

The unified query service may resolve target ids for a portion of the source ids by searching the first identity space. At step 1008, the unified query service may extract a first set of identity records from the initial identity space (e.g., the first identity space). Each of the identity records in the first set of identity records may include a lookup id that matches one of the source ids and one or more target ids. The identity records in the first set of identity records may also include other identifiers and/or identity attributes. The unified query service may determine a remaining portion of the source ids that have not been resolved in the first set of identity records by filtering out the source ids that do not match at least one of the lookup ids in the first set of identity records.

At step 1010, the unified query service may access a next identity space (e.g., a second identity space) to determine target ids for the unresolved portion of the source ids. The second identity space may correspond to a next path (e.g., a second path) having a next search priority (e.g., a second search priority) in the unified query. The location of the second identity space (e.g., datastore and graph name, table name, and the like) may be determined from the step data generated by the steps API for the steps included in the second path. The path having the second search priority may include an indirect path from a source id having a highest matching priority to a target id. The indirect path may include a sequence of multiple steps with each step in the sequence representing a different identity space. Each consecutive pair of identity spaces may be linked by a linking identifier having an identifier type that appears in both of the identity spaces. For example, the second path may include “cookie-cookie” and “cookie-email” steps with a cookie id as the linking identifier. The unified query service may determine the “cookie-cookie, cookie-email” path has the second highest search priority based on the matching priority of the linking identifier and/or the number of hops. For example, the unified query service may determine a second highest search priority for the “cookie-cookie, cookie-email” path because it includes an identifier type having the highest matching priority as a linking identifier (e.g., cookie id) and includes the minimum number of hops (e.g, 1) to get from an identity space that includes a source id to an identity space that includes target ids. The unified query service may determine lower priorities for paths that include more hops and/or linking identifiers that have lower matching priorities.

At step 1012 the unified query service extracts, from the next identity space (e.g., the second identity space) one or more linking identifiers for a remaining portion of unresolved source ids (e.g., source ids that do not match a lookup id in the first set of identity records). The identifier type of the linking ids may correspond to the identifier type for the lookup id so that the linking ids may be used to locate identity records in the first identity space.

The unified query service may resolve target ids for the remaining portion of source ids by searching the first identity space on the linking ids. At step 1014, the unified query service may extract a next set of identity records (e.g., a second set of identity records) from the initial identity space (e.g., first identity space). Each of the identity records in the second set of identity records may include a lookup id that matches one of the multiple linking ids extracted from the second identity space and one or more target ids

At step 1018, the unified query service may then determine if a complete search for the identity data requested by the data request has been performed. A complete search for identity data may be performed when all of the source ids have been resolved and or all of the available identity spaces have been searched. The unified query service may determine if all of the source ids have been resolved by searching the first and second sets of identity records for one or more target ids that are linked to each source id. If, the unified query service determines there is at least one target id for each source id and/or all of the available identity spaces have been searched (e.g., a complete search has been performed and Yes at step 1018), the identity data included in the first and second sets of identity records may be filtered based on the resolution scheme, at step 1016. For example, the identity data may be filtered to remove identifiers linked to one or more source ids that exceed a maximum number of links per identifier specified by the resolution rules of the resolution scheme.

At step 1020, a graph constructor may construct an identity subgraph using the filtered identity data. The identity subgraph may include an identity cluster for each of the multiple source ids that were included in the data request and each identity cluster may include a unified id used to identify the user associated with the identity data in the cluster. The unified id may be unique for each user included an identity subgraph generated by the graph constructor and the unified ids may be used to rapidly locate identity clusters and identity data for a particular user.

If the unified query service determines target ids have not been resolved for one or more of the source ids and/or one or more available identity spaces have not been searched (e.g., a complete search has not been performed and No at step 1018), the unified query service may resolve target ids for the remaining source ids, at step 1022, by searching a new identity space (e.g., a third identity space) included in a next priority path (e.g., a third priority path). To determine target ids for the remaining unresolved source ids, the unified query service may use the search priorities for the paths included in the unified query to select a next identity space to search. If the path having the next highest search priority (e.g., the third search priority) is an indirect path, the unified query service may perform steps 1010-1014 to extract a next set of identity records (e.g., a third set of identity records) from a new (or original) initial identity space. For example, the unified query service may access the next identity space identified by a next priority path (e.g., a third identity space included in the path having the third search priority), extract a linking identifier from a next identity space (e.g. the third identity space), and extract a next of identity records (e.g., a third set of identity records) from the new or original next identity space (e.g., a fourth identity space or first identity space respectively) by querying on the newly extracted linking identifiers. The unified query service may repeat steps 1010-1014 to search the new identity spaces (e.g., a third, fourth, fifth, and so on identity space) included in indirect paths.

If the path having the next highest search priority is a direct path, the unified query service may perform steps 1006-1008 to extract a next set of identity records (e.g., third set of identity records) from a new (or original) initial identity space (e.g., a third identity space or first identity space respectively) by querying on an unresolved source id that matches the identifier type in the path having next highest search priority. The unified query service may determine if each path having a next search priority is a direct path or an indirect path and repeat steps 1006-1008 for each direct path and steps 1010-1014 for each indirect path to search additional identity spaces (e.g., a third, fourth, fifth, and so on identity space).

After the identity spaces in each path have been searched, the unified query service may determine if a complete search has been performed at step 1018 and continue searching additional identity spaces by repeating steps 1010-1014 and/or 1006-1008 until target ids for all of the source ids have been resolved and/or all of the available identity spaces have been searched. Identity data in every set of identity records (e.g., the first, second, third, and so on sets of identity records) may be filtered at step 1016 and an identity subgraph may be constructed at step 1020 using the filtered identity data.

In this disclosure, the following definitions may apply in context. A “Client Device” or “Electronic Device” refers to any machine that interfaces to a communications network to obtain resources from one or more server systems or other client devices. A client device may be, but is not limited to, a mobile phone, desktop computer, laptop, portable digital assistant (PDA), smart phone, tablet, ultra-book, netbook, laptop, multi-processor system, microprocessor-based or programmable consumer electronic system, game console, set-top box, or any other communication device that a user may use to access a network.

“Communications Network” refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and coupling may be a Code Division Multiple Access (CDMA) connection, a Global System for Mobile communications (GSM) connection, or another type of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

“Component” (also referred to as a “module”) refers to a device, physical entity, or logic having boundaries defined by function or subroutine calls, branch points, application programming interfaces (APIs), or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components.

A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors.

It will be appreciated that the decision to implement a hardware component mechanically, in dedicated and permanently configured circuitry, or in temporarily configured circuitry (e.g., configured by software) may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instant in time. For example, where a hardware component includes a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instant of time and to constitute a different hardware component at a different instant of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

“Machine-Readable Medium” in this context refers to a component, device, or other tangible medium able to store instructions and data temporarily or permanently and may include, but not be limited to, random-access memory (RAM), read-only memory (ROM), buffer memory, flash memory, optical media, magnetic media, cache memory, other types of storage (e.g., Erasable Programmable Read-Only Memory (EPROM)), and/or any suitable combination thereof. The term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., code) for execution by a machine, such that the instructions, when executed by one or more processors of the machine, cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“Processor” refers to any circuit or virtual circuit (a physical circuit emulated by logic executing on an actual processor) that manipulates data values according to control signals (e.g., “commands,” “op codes,” “machine code,” etc.) and which produces corresponding output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), or any combination thereof. A processor may further be a multi-core processor having two or more independent processors (sometimes referred to as “cores”) that may execute instructions contemporaneously.

A portion of the disclosure of this patent document may contain material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

Although the subject matter has been described with reference to specific example embodiments, it will be evident that various modifications and changes may be made to these embodiments without departing from the broader spirit and scope of the disclosed subject matter. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Description, therefore, is not to be taken in a limiting sense, and the scope of various embodiments is defined only by any appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A system comprising a database server configured to store and manage multiple identity spaces;
a plurality of client devices configured to provide data requests; and
an identity resolution server electronically connected to the database server and the plurality of client devices, the identity resolution server configured to:
receive a data request including multiple source identifiers (source ids) and a target identifier type for a target identifier (target id);
generate a unified query that determines one or more target ids for each source id of the multiple source ids, the unified query including a resolution scheme and multiple paths, each of the multiple paths including one or more steps;
determine search priorities for each of the multiple paths based on a matching priority for each of the multiple identifier types included in each step;
query a first identity space on the source ids to extract a first set of identity records that include one or more target ids associated with a lookup identifier that matches at least one of the source ids, the first identity space corresponding to the path of the multiple paths having a highest search priority;
determine a portion of unresolved source ids by filtering out the source ids that match at least one of the lookup identifiers in the first set of identity records;
query a second identity space on the unresolved source ids to extract a linking identifier for one or more of the unresolved source ids, the second identity space corresponding to the path of the multiple paths having a next search priority;
query the first identity space on the one or more linking identifiers to extract a second set of identity records that includes one or more target ids and a lookup identifier that matches at least one of the one or more linking identifiers for an unresolved source id; and
construct an identity subgraph that includes identity data stored in the first and second sets of identity records.

2. The system of claim 1, wherein the search priority for a particular path of the multiple paths is further based on a number of hops between identity spaces included in the particular path.

3. The system of claim 1, wherein the identity data includes one or more of the source ids, target ids, and linking ids and one or more identity attributes.

4. The system of claim 1, wherein the identity subgraph includes an identity cluster for each of the multiple source ids that were resolved by the unified query.

5. The system of claim 4, wherein the identity resolution server is further configured to determine a unified identifier for each identity cluster.

6. The system of claim 1, wherein the identity resolution server is further configured to determine mapping data for a set of available identity spaces, the mapping data including each identifier type included in each of the available identity spaces and one or more pieces of identity space metadata.

7. The system of claim 6, wherein the identity resolution server is further configured to determine a step sequence for each step based on the mapping data, each step sequence including one or more steps that each correspond to an identity space, the one or more steps each including two or more identifier types of identifiers that appear in the identity space.

8. The system of claim 1, wherein the identity resolution server is further configured to filter at least one of the first set of identity records and the second set of identity records based on a maximum number of links per identifier included in the resolution scheme.

9. The system of claim 1, wherein the identity resolution server is further configured to determine the first identity space is included in at least two of the multiple paths; and
store, in cache memory, a set of identity records included in the first identity space.

10. The system of claim 1, wherein the identity resolution server is further configured to determine the linking ids are included in at least two of the multiple paths; and
store, in cache memory, the second set of identity records that include the linking ids.

11. The system of claim 1, wherein the first identity space includes identifiers having an identifier type that has a highest matching priority in the resolution scheme.

12. The system of claim 1, wherein the first identity space and the second identity space are asymmetrical.

13. A method of generating a graph representation of multiple identity spaces, the method comprising: comprising a database server configured to store and manage multiple identity spaces;
receiving a data request including multiple source identifiers (source ids) and a target identifier type for a target identifier (target id);
generating a unified query that determines one or more target ids for each source id of the multiple source ids, the unified query including a resolution scheme and multiple paths, each of the multiple paths including one or more steps;
determining search priorities for each of the multiple paths based on a matching priority for each of the multiple identifier types included in each step;
querying a first identity space on the source ids to extract a first set of identity records that include one or more target ids associated with a lookup identifier that matches at least one of the source ids, the first identity space corresponding to the path of the multiple paths having a highest search priority;
determining a portion of unresolved source ids by filtering out the source ids that match at least one of the lookup identifiers in the first set of identity records;
querying a second identity space on the unresolved source ids to extract a linking identifier for one or more of the unresolved source ids, the second identity space corresponding to the path of the multiple paths having a next search priority;
querying the first identity space on the one or more linking identifiers to extract a second set of identity records that includes one or more target ids and a lookup identifier that matches at least one of the one or more linking identifiers for an unresolved source id; and
constructing an identity subgraph that includes identity data stored in the first and second sets of identity records.

14. The method of claim 13, wherein the search priority for a particular path of the multiple paths is further based on a number of hops between identity spaces included in the particular path.

15. The method of claim 13, wherein the identity data includes one or more of the source ids, target ids, and linking ids and one or more identity attributes.

16. The method of claim 13, wherein the identity subgraph includes an identity cluster for each of the multiple source ids that were resolved by the unified query.

17. The method of claim 13, further comprising determining mapping data for a set of available identity spaces, the mapping data including each identifier type included in each of the available identity spaces and one or more pieces of identity space metadata.

18. The method of claim 17, further comprising determining a step sequence for each step based on the mapping data, each step sequence including one or more steps that each correspond to an identity space, the one or more steps each including two or more identifier types of identifiers that appear in the identity space.

19. The method of claim 13, further comprising determining the first identity space is included in at least two of the multiple paths; and
storing, in cache memory, a set of identity records included in the first identity space.

20. The method of claim 13, wherein the first identity space and the second identity space are asymmetrical.
